(19) United States
(12) Patent Application Publication
(10) Pub. No.: US 2016/0007243 A1
(43) Pub. Date: Jan. 7, 2016

(54) METHOD AND APPARATUS OF MOBILITY MANAGEMENT IN SMALL CELL ENVIRONMENT

(71) Applicant: Electronics and Telecommunications Research Institute, Daejeon (KR)

(72) Inventors: Soon Gi PARK, Daejeon (KR); Pyeong Jung SONG, Daejeon (KR); Yeon Seung SHIN, Daejeon (KR)

(21) Appl. No.: 14/455,000

(22) Filed: Aug. 8, 2014

(30) Foreign Application Priority Data
Jul. 2, 2014 (KR) 10-2014-0082439

(51) Int. Cl. H04W 36/00; H04W 24/10

(52) U.S. Cl. CPC H04W 36/0033; H04W 24/10; H04W 36/0055

(57) ABSTRACT

The present invention relates to a wireless communication system that supports the mobility management in a small cell environment, the wireless communication system includes a user equipment configured to measure a signal strength of multiple small cells around and transmit the measurement result through a serving cell, and a multiple small base stations configured to store user equipment context information in determined preparation cells among the multiple small cells based on the measurement result, in case that the user equipment context information for cell A among the preparation cells is changed, wherein the multiple small base stations update the changed user equipment context information.

Priority to Korean patent application number 2014-0082439 filed on Jul. 2, 2014, the entire disclosure of which is incorporated by reference herein, is claimed.

### BACKGROUND OF THE INVENTION

1. Field of the Invention

The present invention relates to wireless communications, and more particularly, to a method and apparatus for mobility management in small cell environment.

2. Discussion of the Related Art

A cellular mobile communication system is a system in which respective different frequencies are allocated to neighboring cells with the mobile communication service regions being divided into several cell units, and the arrangement of the cells is made in order to reuse the frequency spatially by using the same frequency band for the two cells between which there is no occurrence of any interferences due to being faraway from each other, or a separate interference control method may be used while the same frequency is allocated to the neighboring cells.

A user equipment (UE) that connects through the wireless access network provided by such a cellular mobile communication system may perform communication by residing in or connecting to unprescribed cell, and perform cell change. In case that cell change is made in an environment that a communication is performed by connecting to a cell, a handover may be performed in order to solve the problem of call severance. The handover is referred to as a function that a stable state of telephone conversation is maintained by an automatic tuning being made on a new traffic channel of the adjacent communication service region when a UE gets out of the present communication service region (hereinafter, source cell) and moves to the adjacent communication service region (hereinafter, target cell) as the UE moves.

There are mainly three methods for preparing for heavy increase of traffics in this mobile communication system. The first method is to increase the spectral efficiency of frequency, the second method is to further increase using frequency bands, and the third method is to increase the density of small cells.

In case of selecting the third method in which small cells are dense, due to the nature of the small cells that the coverage is relatively small in small cell environment, the radio link failure (RLF) or the cell change according to the movement of a UE may frequently occur compared with the existing mobile communication system. In this case, the mobile management of the UE should be performed, however, the mobile management method considered in the current mobile communication system (particularly long term evolution (LTE) or LTE-Advanced (LTE-A), hereinafter, LTE may include LTE-A) has a problem that is not optimized in the capacity-based small cell deployment environment, since it is based on the macro cell coverage based cell arrangement. For example, there exists the recovery procedure for the RLF as one of the mobile management methods in the current mobile system, but as it is optimized in the macro cell, a problem may arise that the RLE recovery performance is deteriorated if it is applied to the small cell as it is. Consequently, the mobile management method that is optimized in small cell environment is required.

### SUMMARY OF THE INVENTION

It is a principal object of the present invention is to provide a method and apparatus for mobility management in small cell environment.

It is another object of the present invention is to increase the recovery performance for the radio link failure (RLF) in small cell environment.

It is further object of the present invention is to provide the UE context information management method for the small cell environment.

It is still further object of the present invention is to provide a method and apparatus for the UE mobility management based on the multiple preparation method (MPM).

It is further object of the present invention is to provide a method and apparatus for the UE mobility management based on the context fetch method (CFM).

According to an aspect of the present invention, a wireless communication system that supports mobility management in a small cell environment is provided. The wireless communication system includes a user equipment configured to measure a signal strength of multiple small cells around and transmit the measurement result through a serving cell, and multiple small base stations configured to store user equipment context information in determined preparation cells among the multiple small cells based on the measurement result, in case that the user equipment context information for cell A among the preparation cells is changed, wherein the multiple small base stations update the changed user equipment context information.

Also, the small cells of which signal strength exceed a threshold value Tprep for preparation based on the measurement result of the user equipment may be determined to be the preparation cells.

Also, the user equipment context information for the preparation cells may include physical IDs of each of the cells and C-RNTI of the user equipment for the corresponding cell.

Also, in case that signal strength of cell B among the multiple small cells exceeds the threshold value Tprep for the preparation, the serving base station may transmit multiple preparation request message that includes the user equipment context information for the preparation cells to small base station B that operates cell B, the small base station B may transmit multiple preparation request ACK message that includes the user equipment context information for corresponding cell B to the serving base station, and the serving base station may transmit preparation information transfer message that indicates to add the user equipment context information for cell B to the remainder base stations except the serving base station.

Also, in case that signal strength of cell C among the preparation cells is the same or smaller than the threshold value Tcancel for release of the preparation, the serving base station may transmit multiple preparation deletion message that indicates un-preparation of cell C to small base station C and remainder base stations except the serving base station among the multiple base stations.

Also, a change of the user equipment context information for the cell A may be generated as the user equipment succeeds the radio link failure recovery to corresponding cell A. In this case, the change of the user equipment context information for cell A may be that C-RNTI of the user equipment for cell A is changed.

Also, the serving base station may transmit a multiple preparation request message that instructs to update the changed user equipment context information for cell A to remainder base stations except the serving base station among the multiple base stations, and the remainder base stations may update the changed user equipment context information based on the multiple preparation request message.

According to an aspect of the present invention, a small base station A that supports mobility management in a small cell environment is provided. The small base station A includes a receiving unit configured to receive a first measurement report including a first measurement result for cell B from a user equipment through cell A, a storage unit configured to store user equipment context information for cell A, a control unit configured to perform a preparation decision for cell B in case that signal strength of cell B exceeds a threshold value Tprep for preparation based on the first measurement result for cell B, and generates a first multiple preparation request message including the user equipment context information for cell A, and a transmitting unit configured to transmit the first multiple preparation request message generated to a small base station B that operates cell B, wherein the receiving unit receives a first multiple preparation request ACK message including the user equipment context information for cell B from small base station B, and wherein the control unit controls such that the user equipment context information for the cell B as well as the user equipment context information for cell A is to be stored in the storage unit.

According to yet another aspect of the present invention, a method of mobility management in small cell environment is provided. The method includes receiving a first measurement report including a first measurement result for cell B from a user equipment through cell A, storing user equipment context information for cell A, performing a preparation decision for cell B in case that signal strength of cell B exceeds a threshold value Tprep for preparation based on the first measurement result for cell B, generating a first multiple preparation request message including the user equipment context information for cell A, transmitting the first multiple preparation request message generated to a small base station B that operates cell B, receiving a first multiple preparation request ACK message including the user equipment context information for cell B from small base station B, and controlling such that the user equipment context information for the cell B as well as the user equipment context information for cell A is to be stored in the storage unit.

### BRIEF DESCRIPTION OF THE DRAWINGS

FIG. 1 illustrates a wireless communication system in which the present invention is applied.

FIG. 2 illustrates an example of the handover procedure in a wireless communication system.

FIG. 3 shows an example of the RLF recovery in case of maintaining the UE context information in multiple cells.

FIG. 4 illustrates a conceptual diagram for the MPM according to an embodiment of the present invention.

FIG. 5 illustrates an example of sharing the UE context information among multiple small cells.

FIG. 6 illustrates an example of the mobility path of a UE.

FIG. 7 illustrates examples of events occurred according to the position of a UE in FIG. 6.

FIGS. 8 to 10 below illustrate examples of the MPM operation procedure according to the position of a UE in FIG. 6.

FIG. 11 and FIG. 12 illustrate an example of the preparation procedure according to the MPM of the present invention.

FIG. 13 and FIG. 14 illustrate an example of the preparation procedure according to the MPM of the present invention.

FIG. 15 and FIG. 16 illustrate still another example of the preparation procedure according to the MPM of the present invention.

FIG. 17 illustrates a conceptual diagram for the CFM according to another embodiment of the present invention.

FIG. 18 illustrates a problem that occurs when performing the RLF recovery to a small cell according to the CFM.

FIG. 19 illustrates an example of the mobility path of a UE.

FIG. 20 illustrates examples of the event that occurs according to the position of a UE in FIG. 19.

FIG. 21 to FIG. 24 illustrates an example of the CFM operation procedure according to the position of a UE in FIG. 19.

FIG. 25 illustrates another example of the mobility path of a UE.

FIG. 26 illustrates examples of the event that occurs according to the position of a UE in FIG. 25.

FIG. 27 to FIG. 32 illustrates an example of the CFM operation procedure according to the position of a UE in FIG. 25.

FIG. 33 is a block diagram schematically illustrating the eNB that performs the UE mobility management based on the MPM of the present invention.

FIG. 34 is a block diagram schematically illustrating the eNBs that perform the UE mobility management based on the CFM of the present invention.

### DETAILED DESCRIPTION OF THE INVENTION

Hereinafter, the preferred embodiment of the present invention now will be described in detail by reference to the accompanying exemplary drawings in this specification. In attaching reference numerals to elements in each drawing, it should be understood that the same reference numeral is used for the same element even if the element is shown in different drawings. In addition, in case that the detailed description for the related known elements and functions is determined to obscure the inventive concept in this specification, the redundant description for the same element will be omitted.

In addition, the present specification describes wireless communication network as an object, the tasks performed in the wireless communication network may be performed during the process of controlling the network in the system (for example, a base station) that controls the corresponding wireless communication network and transmitting data, or performed by the user equipment that is coupled to the corresponding wireless network.

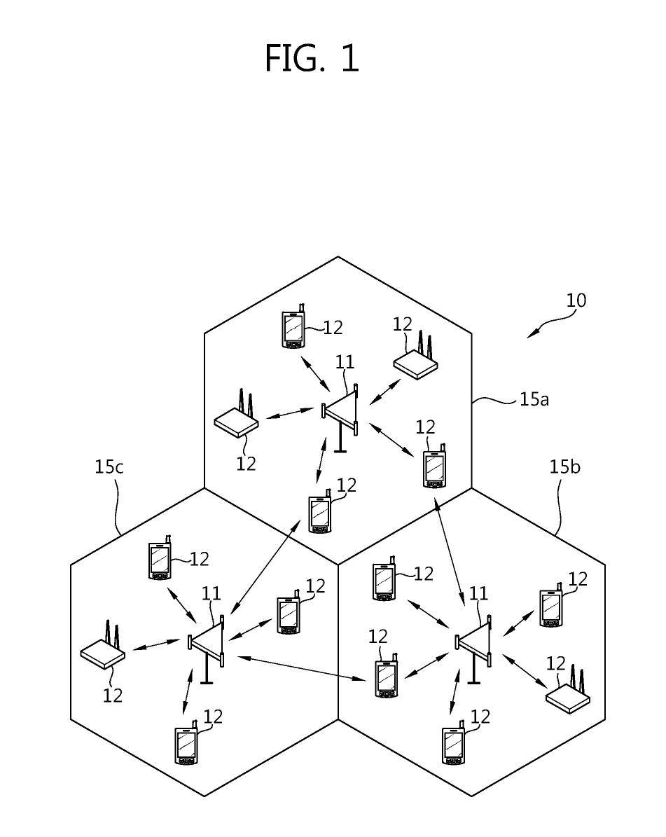

FIG. 1 illustrates a wireless communication system to which the present invention is applied. The wireless communication system to which the present invention is applied may include, for example, 3GPP LTE system and 3GPP LTE-advanced (LTE-A) system.

Referring to FIG. 1, the wireless communication system 10 is widely disposed in order to provide various communication services such as voice, packet data, and so on. The wireless communication system 10 includes at least one evolved-NodeB (eNB) 11. Each base station 11 provides communication services for specific cells 15a, 15b and 15c. A base station may be in charge of multiple cells. The base station 11 refers to a transmission and reception terminal that performs sharing information, control information, and so on with a user equipment for cellular communication, and may be called other terms such as a Base Station (BS), a Base Transceiver System (BTS), an Access Point (AP), a femto eNB, a Home nodeB, relay, and so on. The cell may include various coverage areas such as a mega cell, a macro cell, a micro cell, a pico cell, a femto cell, and the like.

A user equipment (UE) 12 may be fixed or have mobility, and may be called other terms such as a mobile station (MS), a mobile terminal (MT), a user terminal (UT), a subscriber station (SS), a wireless device, a personal digital assistant (PDA), a wireless modem, a handheld device, and the like.

Hereinafter, downlink refers to transmission link from the eNB 11 to the UE 12 and uplink refers to transmission link from the UE 12 to the eNB 11. In downlink, a transmitter may be a part of the eNB 11 and a receiver may be a part of the UE 12. In uplink, a transmitter may be a part of the UE 12 and a receiver may be a part of the eNB 11. There is no limitation in the multi access method which is applied to the wireless communication system. Various multi access methods may be used such as Code Division Multiple Access (CDMA), Time Division Multiple Access (TDMA), Frequency Division Multiple Access (FDMA), Orthogonal Frequency Division Multiple Access (OFDMA), Single Carrier-FDMA (SC-FDMA), OFDM-FDMA, OFDM-TDMA, OFDM-CDMA. As the uplink transmission and the downlink transmission, a Time Division Duplex (TDD) scheme transmitted using different times and a Frequency Division Duplex (FDD) scheme transmitted using different frequencies.

The layers of the radio interface protocol between the UE 12 and the eNB 11 may be divided into the first layer (L1), the second layer (L2) and the third layer (L3) based on the lower three layers of the Open System Interconnection (OSI) model which is well known in communication systems. Among the layers, the physical layer which is included in the first layer provides the information transfer service using physical channel, and the Radio Resource Control (RRC) layer which is located on the third layer exchanges RRC messages and controls the radio resources between the UE and the network. The RRC layer is in relation to the configuration, re-configuration and release of Radio Bearer (RB), and in charge of controlling logical channels, transmission channels and physical channels. The RB means the logical path which is provided by the first layer (PHY layer) and the second layer (Medium Access Control (MAC) layer, Radio Link Control (RLC) layer and Packet Data Convergence Protocol (PDCP) layer) for data transmission between the UE and network. The RB is divided by Signaling RB (SRB) and Data RB (DRB) again. The SRB is used for the path to transmit RRC messages and Non-Access Stratum (NAS) messages on control plane, and the DRB is used for the path to transmit user data on user plane.

There exist a few physical channels used in the physical layer. As a downlink physical channel, the physical downlink control channel (PDCCH) may notify the resource allocation of Paging Channel (PCH) and Downlink Shared Channel (DL-SCH) and Hybrid Automatic Repeat Request (HARQ) information in relation to the DL-SCH. The PDCCH may carry the uplink grant that notifies the resource allocation of the uplink transmission. The UE may perform monitoring the PDCCH based on cell-radio network temporary identifier (C-RNTI) which is an intrinsic identifier of the UE. The DL-SCH is mapped to a Physical Downlink Shared Channel (PDSCH). A physical control format indicator channel (PCFICH) notifies the number of OFDM symbol which is used for the PDCCHs to the UE, and is transmitted in every frame. A Physical Hybrid ARQ Indicator Channel (PHICH) is a downlink channel, carries Hybrid Automatic Repeat Request (HARQ) Acknowledgement (ACK)/Non-acknowledgement (NACK) signals which are the responses to the uplink transmission. The HARQ ACK/NACK signals may be called the HARQ-ACK signal.

As an uplink physical channel, the physical uplink control channel (PUCCH) carries the uplink control information such as the HARQ-ACK which is the response to the downlink transmission and channel status information (CSI) that represents downlink channel state, such as a Channel Quality Indicator (CQI), a precoding matrix index (PMI), a precoding type indicator (PTI), rank indicator (RI), and so an. A Physical Uplink Shared Channel (PUSCH) carries an Uplink Shared Channel (UL-SCH). A Physical Random Access Channel (PRACH) carries a random access preamble.

The UE that accesses the network may perform communication with an unprescribed cell according to channel environment and mobility state, or may perform cell change. In case of the cell change, handover (HO) may be performed to solve the problem of call severance that occurs when moving to neighboring cell.

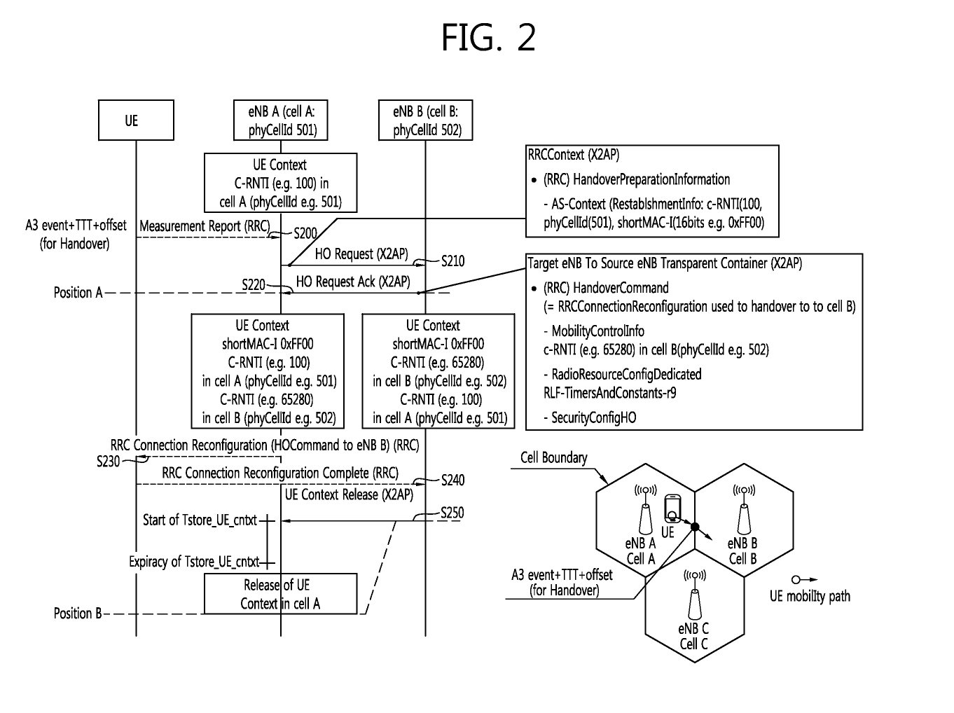

FIG. 2 illustrates an example of the handover procedure in a wireless communication system. In FIG. 2, the eNB A may be called the source eNB and the eNB B may be called the target eNB. It is assumed that the cell A is provided through the eNB A and the cell B is provided through the eNB B. For example, the physical cell ID (phyCellId) of the cell A may be 501, and the physical cell ID (phyCellId) of the cell B may be 502. The eNB A has the UE context information for the UE. The UE context information includes the C-RNTI for the UE at the cell A. For example, the C-RNTI value for the EU at the cell A may be 100.

Referring to FIG. 2, the UE performs a measurement report to the eNB A (step, S200). After the UE measures the serving cell and/or neighboring cell, and report the measurement result to the eNB of the serving cell. This is referred to as the measurement report, and the measurement report includes a periodic report and an event-triggered report. Among those, as for the event-triggered report, the triggering of the event to report includes event A1 (in case that the measurement report of the serving cell is greater than a predetermined threshold value), event A2 (in case that the measurement report of the serving cell is smaller than a predetermined threshold value), event A3 (in case that the measurement report of the neighboring cell is greater than a predetermined offset), event A4 (in case that the measurement report of the neighboring cell is greater than a predetermined threshold value) and event A5 (in case that the measurement report of the serving cell is smaller than that of the neighboring cell by a predetermined offset), and in case of inter-RAT mobility, there are event B1 (in case that the measurement report of the neighboring cell is greater than a predetermined threshold value) or event B2 (in case that the measurement report of the serving cell is smaller than that of the neighboring cell by a predetermined threshold value). For example, the measurement report may be event A3, and may include time to trigger (TTT) and offset.

eNB A determines whether handover is performed based on the measurement report and transmits handover request (HO request) to eNB B (step, S210), and receives request Ack (HO request Ack) message from eNB B. In this case, the UE may be positioned at position A which is adjacent to the boundary of cell A.

The handover request message may include, for example, handover preparation information (HandoverPreparationInformation). The handover preparation information may include the C-RNTI for the UE at cell A and the physical cell ID of cell A. In addition, the handover request Ack message may include the information for handover command. The information for handover command may include the C-RNTI for the UE at cell B and the physical cell ID of cell B. The handover request message and the handover request Ack message may be transmitted through X2 interface. The X2 interface may be called X2 Application Protocol (X2AP). In this case, eNB A and eNB B may include both of the C-RNTI for the UE at cell A and C-RNTI for the UE at cell B as the UE context information.

eNB A transmits the handover command for eNB B to a UE through the RRC connection reconfiguration message (step, S230). The UE configures a radio link with eNB B based on the handover command, and transmits the RRC connection reconfiguration complete message to eNB B (step, S240). Later, eNB B transmits UE context release message to eNB A (step, S250). In this case, the UE may be positioned as position B passing through the region where cell A and cell B are overlapped. The UE context release message may be transmitted through X2 interface.

After eNB A receives the UE context release message, eNB A drives UE context storing timer Tₛₜₒᵣₑ_{_{—}}_{UE}_{_{—}}_{cntx}, and release the UE context information at cell A when the timer is terminated (step, S260).

In the current standard in relation to the handover procedure, the important information which is exchanged between two eNBs includes the physical cell ID of each cell of each eNB and the C-RNTI for the UE. In addition, these two parameters are the important parameters that are available to find which is the UE context information relevant to the UE that tries RLF recovery among the pieces of UE context information kept by the cell in which the RLF recover is tried, even in case of the Radio Link Failure (RLF). For example, the channel quality becomes deteriorated during the handover procedure and the RLF may occur during preparing the handover, or in case of not receiving the handover command within a predetermined time due to the bad link state, the signal from the source eNB is becoming weak and the RLF may occur.

Table 1 below represents the possibility of the RLF recovery to each cell according to position in case that the RLF occurs during the handover procedure.

TABLE 1

| | RLF recovery to | RLF recovery to | RLF recovery to |
|---|---|---|---|
| | cell A | cell B | cell C |
| Position A | Possible | Impossible | Impossible |
| | (Prepared cell) | (Unprepared cell) | (Unprepared cell) |
| Position A~ | Possible | Possible | Impossible |
| Position B | (Prepared cell) | (Prepared cell) | (Unprepared cell) |
| Position B | Impossible | Possible | Impossible |
| | (Unprepared cell) | (Prepared cell) | (Unprepared cell) |

Referring to Table 1, in case that a UE tries the RLF recovery at position A, the RLF recovery to cell A is possible, but the RLF recovery to cell B or cell C is impossible. This is because only eNB A keeps the UE context information for the corresponding UE at the corresponding timing. In case that the UE tries the RLF recovery and the like, the cell in which the UE context information for the corresponding UE exists may be defined as the prepared cell. That is, in this case, cell A is the prepared cell and the remainder cells are the unprepared cells.

In addition, in case that a UE tries the RLF recovery between position A and position B, the RLF recover to cell A or cell B is possible, but the RLF recover to cell C is impossible. This is because both of eNB A and eNB B keep the UE context information for the corresponding UE at the corresponding timing. In this case, both cell A and cell B are the prepared cells and cell C is the unprepared cell.

In addition, in case that a UE tries the RLF recovery at position B, the RLF recover to cell B is possible, but the RLF recover to cell A or cell C is impossible. This is because only eNB B keeps the UE context information for the corresponding UE since eNB A releases the UE context information for the corresponding UE at the corresponding timing. In this case, cell B is the prepared cell and the remainder cells are the unprepared cells.

In case that the RLF occurs and the UE tries the RLF recovery when complying with the current long term evolution (LTE, including LTE-A) standard, as aforementioned, normally it is available for the RLF recovery to a specific cell, exceptionally, in the section (position A and position B) where the UE context information for the corresponding UE is maintained in two eNBs, one cell of the maximum two cells (cell A and cell B) is selected and the RLF recovery may be performed. That is, the RLF recovery in the current LTE standard is available for the maximum two cells and only for a short time will be, therefore, it contains high possibility that the RLF recovery is made to the unprepared cells. Such a try of the RLF recovery that is made to the unprepared cells failed and may cause a service interruption for the UE. In the meantime, in the current standard, in order to avoid the RLF recovery to the unprepared cells, a reactive resource management (for example, mobility robustness optimization (MRO)) is adopted. The active resource management may accompany the mobility parameter adjustment based on statistical information gathering related to the RLF. However, the resource management method for avoiding the RLF recovery try to the unprepared cell in the current mobile communication system, is optimized in homogeneous macro cells.

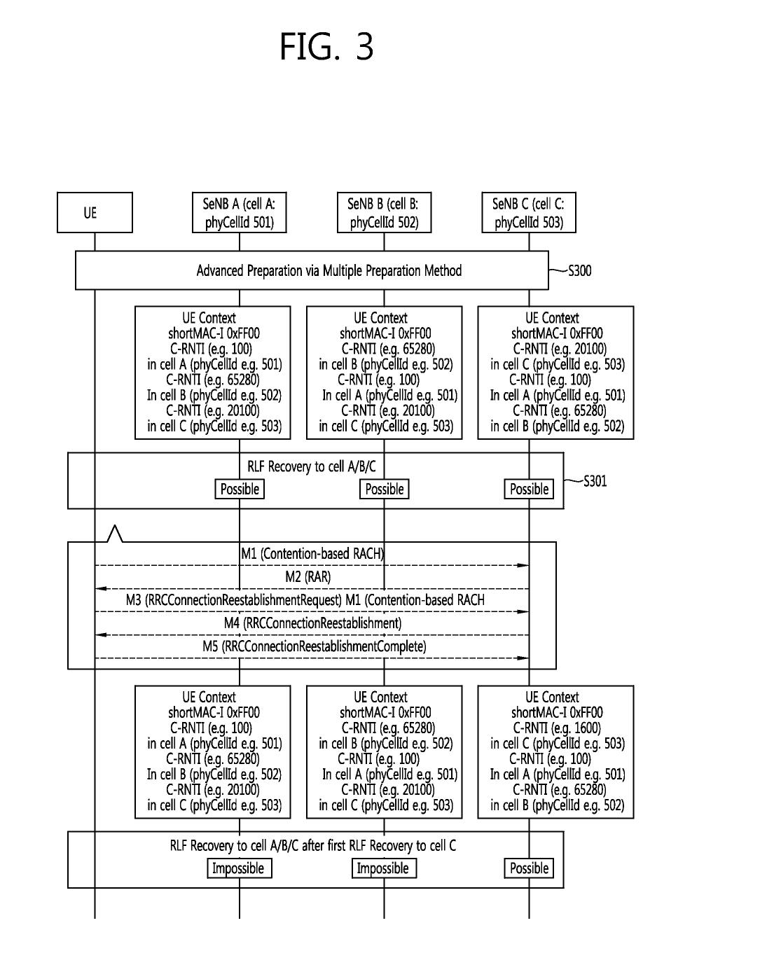

Meanwhile, in order to solve the problem of heavy increase in traffics, currently the way is considered to increase the density of small cells. If following the way of increasing the density of small cells, tries for the RLF recovery increase in number and may happen randomly. In case that the RLF recovery method based on the resource management method optimized in the existing homogeneous macro cells is applied to the heterogeneous network (HetNet) environment where are there exist multiple dense small cells as it is, the performance of the RLF recovery may be deteriorated. As the UE context information is maintained for the current one cell or the maximum for the two cells for a short moment, there is high possibility that the UE tries to the RLF recovery to the cell that are not prepared in the heterogeneous network environment in which there are multiple dense small cells. Accordingly, there is a need of introducing the multiple preparation method (MPM) in which the UE context information is maintained in the multiple cells according to a predetermined condition in order to increase the performance of a UE's RLF recovery and mobility robustness in the heterogeneous network environment. However, in case of introducing the MPM based on the UE context information maintaining method based on the current C-RNTI, as shown in FIG. 3, if a UE performs the RLF recovery to a cell, it is impossible for the UE to perform the RLF recovery to the rest prepared cells.

FIG. 3 shows an example of the RLF recovery in case of maintaining the UE context information in multiple cells. FIG. 3 assumes that there exist cell A of small eNB (SeNB), cell B of small eNB, cell C of small eNB, and assumes that the UE is located at the overlapped position of cell A, cell B, and cell C, and the RLF happens. Herein, cell A, cell B, and cell C are referred to as each small cell A, small cell B, and small cell C.

Referring to FIG. 3, the UE and small eNB A, small eNB B and small eNB C perform the advanced preparation procedure based on MPM (step, S300). In this case, eNB A, small eNB B and small eNB C may retain the UE context information respectively. The UE context information that are possessed by each small eNB includes C-RNTI for the UE in cell A, C-RNTI for the UE in cell B, and C-RNTI for the UE in cell C. That is, cell A, cell B, and cell C are the prepared cells.

The UE performs the RLF recovery procedure through the RRC connection reestablishment request message (step, S310). Herein, as cell A, cell B, and cell C are the prepared cells, the UE may perform any one of cell A, cell B, and cell C. Assuming below that a UE performs the RLF recovery to cell C, the RLF recovery procedure may be performed as below.

The UE performs the contention-based random access procedure. That is, the UE randomly selects one of the contention-based random access preambles, transmits the selected preamble to small eNB C through the random access channel (RACH), and small eNB C transmits the random access response (RAR) message to the UE. In this case, a temporary radio network temporary ID (T-RNTI) that represents a temporary UE ID may be included in the random access response message. For example, the T-RNTI may be determined in the MAC layer. Assuming below that the value of T-RNTI is set to 1600. After that, the UE transmits the RRC connection reestablishment request message to small eNB C. The RRC connection reestablishment request message may include the UE identification information, and the identification information may include the C-RNTI information of the corresponding UE. Small eNB C recognizes the UE by comparing the identification information included in the RRC connection reestablishment request message and the UE context information previously saved. Small eNB C updates the C-RNTI of the corresponding UE in the serving cell C. For example, the UE may update to 1600 from 20100, the existing C-RNTI value.

After that, small eNB C transmits the RRC connection reestablishment message to the UE, the UE performs the parameter change related to the RRC in the UE layer based on the parameter related to the RRC that is included in the RRC connection reestablishment message, and transmits the RRC connection reestablishment complete message to small eNB C.

Meanwhile, since the UE context information of small eNB C only is updated, in this case, the UE may not perform the RLF recovery any more based on the UE context information that is retained in small eNB A and small eNB B. That is, even though the RLF may occur again after the RLF recovery procedure is performed, the RLF recovery to cell A and cell B is impossible, the UE may perform the RLF recovery procedure to only cell C that succeeded in the first RLF recovery.

Accordingly, in case of using the UE context information maintaining method based on the existing C-RNTI even in case of retaining the UE context information in multiple cells, the RLF recovery to another cell is impossible even though the RLF may occur once the RLF recovery procedure is performed.

Therefore, the present invention suggests a method for raising the RLF recovery possibility of small cell in the heterogeneous network environment including multiple dense small cells.

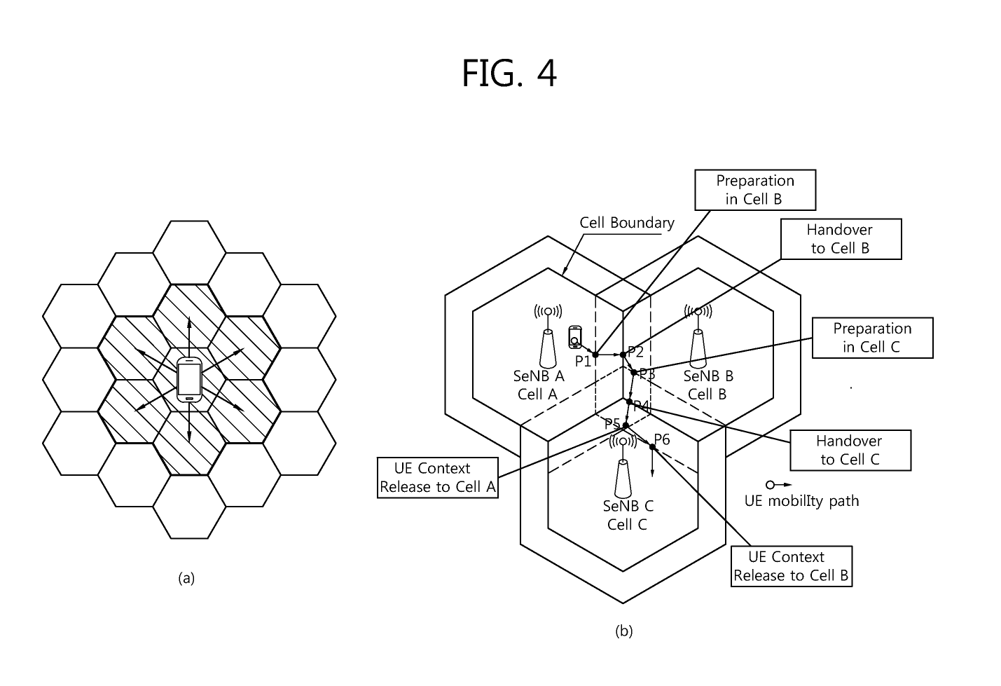

Method 1: The UE Mobility Management Method Based on the Multiple Preparation Method (MPM) FIG. 4 illustrates a conceptual diagram for the MPM according to an embodiment of the present invention.

Referring to FIG. 4, (a) is an example of the MPM and illustrates that the UE performs the preparation for all of the cells in a predetermined range based on the current position (for example, 1 tier or 2 tier cells). Herein, what to perform the preparation may imply that a series of procedures are performed for retaining the UE context information for the corresponding UE.

(b) shows that the preparation for the corresponding cells is done when UEs come in the region where cells are overlapped according to the mobility path of the UE. For example, if the UE moves to P2, the preparations for cell A, cell B, and cell C may be performed, and if the UE moves to P5, cell A may release the UE context information.

In case of being based on the MPM as shown in FIG. 4, the possibility of the RLF recovery may be increased. However, in case that the change of UE context information (for example, addition/deletion of the dedicated bearer) occurs, the signaling load for updating the UE context information in proportional to the number of prepared cell.

Particularly, referring to FIG. 4 (b) again, in case that the UE is positioned at P4 and based on the MPM, the UE has the identical UE context information at cell A, cell B and cell C. In this situation, the UE is available to perform the first RLF recovery to any cell among the three cells. However, when the first RLF recovery is successful, performing the RLF recovery to the remainder two cells is not possible. For example, in case that the first RLF recovery is performed to cell C, the C-RNTI in cell C is allocated again by the MAC entity. Accordingly, in this case, the C-RNTI value may be changed to, for example, 1600 from the existing 20100. When the next RLF occurs, in case that the UE tries to perform the RLF recovery to cell A or cell B, the UE transmits the changed C-RNTI (for example, value 1600), but may not find the matched UE context information in cell A and cell B. Accordingly, in order to prepare next RLF recovery procedure after the first RLF recovery is performed, it is required the procedure for notifying that the C-RNTI is changed to the remainder (prepared) cells from the cell in which the RLF recovery is performed.

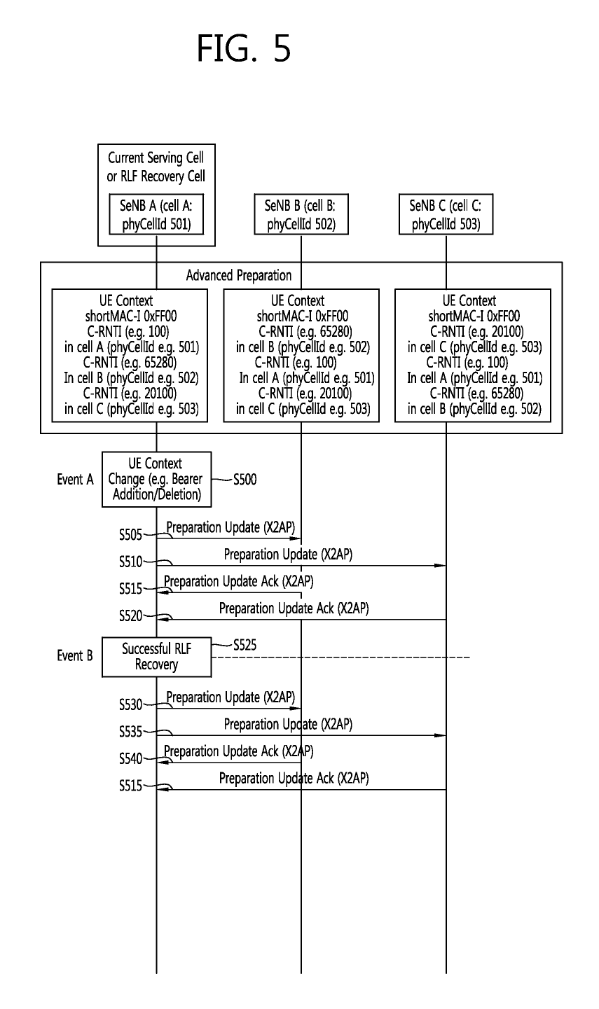

FIG. 5 illustrates an example of sharing the UE context information among multiple small cells.

Referring to FIG. 5, it is assumed the case that the physical cell ID of cell A of eNB A is 501, the physical cell ID of cell B of eNB B is 502 and the physical cell ID of cell C of eNB C is 503. In addition, it is assumed that each of the eNBs perform the advanced preparation based on the MPM. Each of the eNBs may have the C-RNTI at cell A, the C-RNTI at cell B and the C-RNTI at cell C with respect to the UE. For example, the C-RNTI value at cell A may be 100, the C-RNTI value at cell B may be 65280 and the C-RNTI value at cell C may be 20100.

In the situation that a UE is wirelessly linked to cell A as the current serving cell, event A occurs and the UE context information at cell A may be changed (step, S500). For example, event A may include the addition/deletion of the bearer at cell A. In this case, the UE context information of cell B and cell C should be changed. Accordingly, eNB A transmits the preparation update message to eNB B and eNB C (steps, S505 and S510). eNB B and eNB C transmit the preparation update Ack message to eNB A, respectively (steps, S515 and S520). The preparation update message and the preparation update Ack message may be transmitted through the X2 interface.

Meanwhile, later, the RLF occurs to the UE, and the UE may perform the RLF recovery to cell A (event B, step, S525). In case that the RLF recovery is successful, the C-RNCT at cell A for the corresponding UE may be changed as described above. In this case, since the RLF recovery to cell B or cell C becomes impossible, eNB A transmits the preparation update message to eNB B and eNB C (steps, S530 and S535). Based on this, eNB B and eNB C may update the C-RNTI information for cell A at cell B and cell C, and may set up such that the RLF recovery to cell B or cell C is possible. For example, when the UE performs the RLF recovery to cell A, in case the C-RNTI value of the UE for cell A is changed from 100 to 16771, in order to also update the changed C-RNTI value for cell A to cell B and cell C, eNB A may transmit the preparation update message to eNB B and eNB C. Later, each of eNB B and eNB C transmit the preparation update Ack message to eNB A (steps, S540 and S545).

The particular operation of the MPM according to Method 1 of the present invention may be performed as follows.

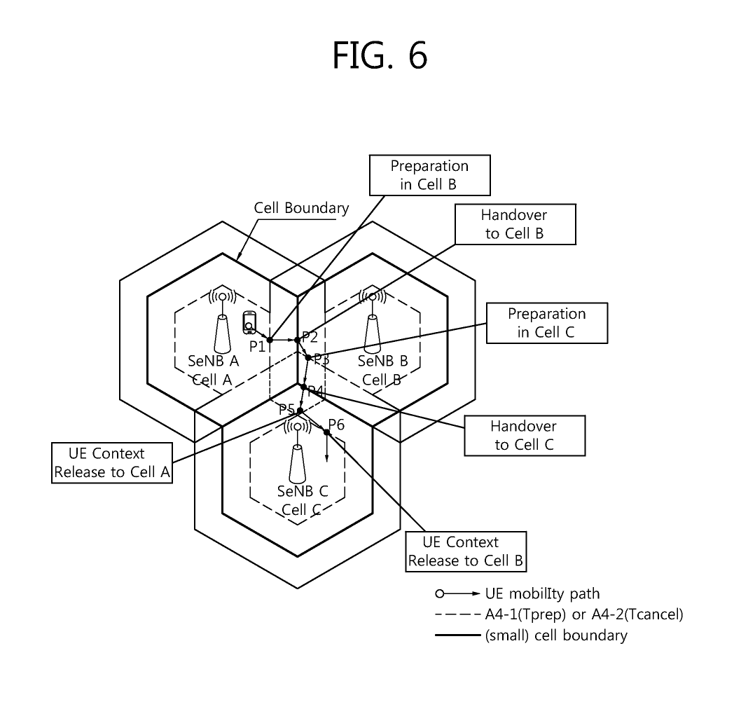

FIG. 6 illustrates an example of the mobility path of a UE.

Referring to FIG. 6, in the network environment where cell A, cell B and cell C exist while being partially overlapped, a UE may sequentially move from position P1 to positions P2, P3, P4, P5 and P6. The dotted lines in FIG. 6 show boundaries for the preparation and release of each cell. For example, in case a UE enters into the inside the dotted line, which may be the case that the measurement result for the corresponding cell is greater than a predetermined threshold value, in this case, it may be considered that the corresponding cell satisfies the threshold value Tprep for the preparation (the event A4-1). In addition, in case that a UE moves out of the dotted line of a cell, it may be considered that the corresponding cell satisfies the threshold value Tcancel for the cancel (or release) for the preparation (the event A4-2). If a UE is positioned at position P1, the UE may perform the preparation procedure in cell B, and if a UE is positioned at position P2, the UE may handover to cell B. In addition, if a UE is positioned at position P3, the UE may perform the preparation procedure in cell C, and if a UE is positioned at position P4, the UE may handover to cell C. Also, if a UE is positioned at position P5, cell A may release the UE context information for the corresponding UE, and if a UE is positioned at position P6, cell B may release the UE context information for the corresponding UE.

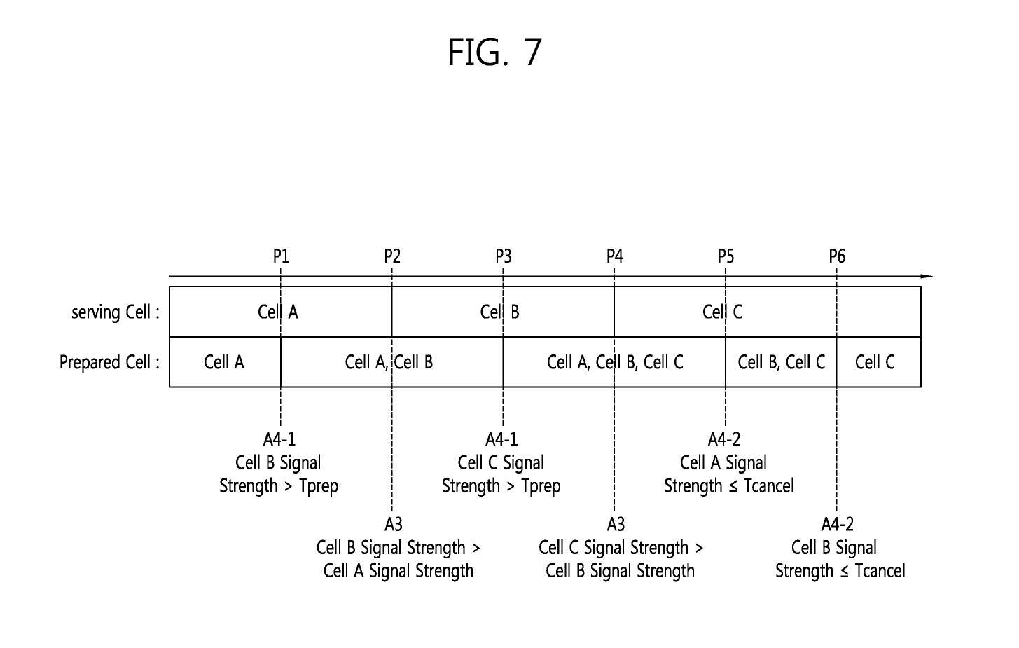

FIG. 7 illustrates examples of events occurred according to the position of a UE in FIG. 6. FIG. 7 particularly shows which event occurs for the position on the moving path of a UE. According to FIG. 7, while a UE undergoing sequential handover from cell A to cell B and cell C, the serving cell is changed, and the prepared cell is changed.

Referring to FIG. 7, initially, the serving cell and the prepared cell for a UE is ell A.

In case that a UE moves to P1 and the signal strength of cell B exceeds Tprep (the event A4-1), cell B as well as cell A are prepared cells.

In case that a UE moves to P2 and the signal strength of cell B becomes greater than that of cell A (event A3-1), the UE performs handover from cell A to cell B. That is, the serving cell is changed to cell B. In this case, the prepared cells are still both of cell A and cell B.

In case that a UE moves to P3 and the signal strength of cell C exceeds Tprep (the event A4-1), cell C as well as cell A and cell B are prepared cells. In this case, the serving cell is still cell B.

In case that a UE moves to P4 and the signal strength of cell C becomes greater than that of cell B (event A3-1), the UE performs handover from cell B to cell C. That is, the serving cell is changed to cell C. In this case, the prepared cells are still cell A, cell B and cell C.

In case that a UE moves to P5 and the signal strength of cell A is smaller than or the same as Tcancel (the event A4-2), cell A cancels (or releases) the preparation, and only cell B and cell C are the prepared cells. In this case, the serving cell is cell C.

In case that a UE moves to P6, since the signal strength of cell B is less than Tcancel (the event A4-2), cell B cancels (or releases) the preparation, and only cell C is the prepared cell.

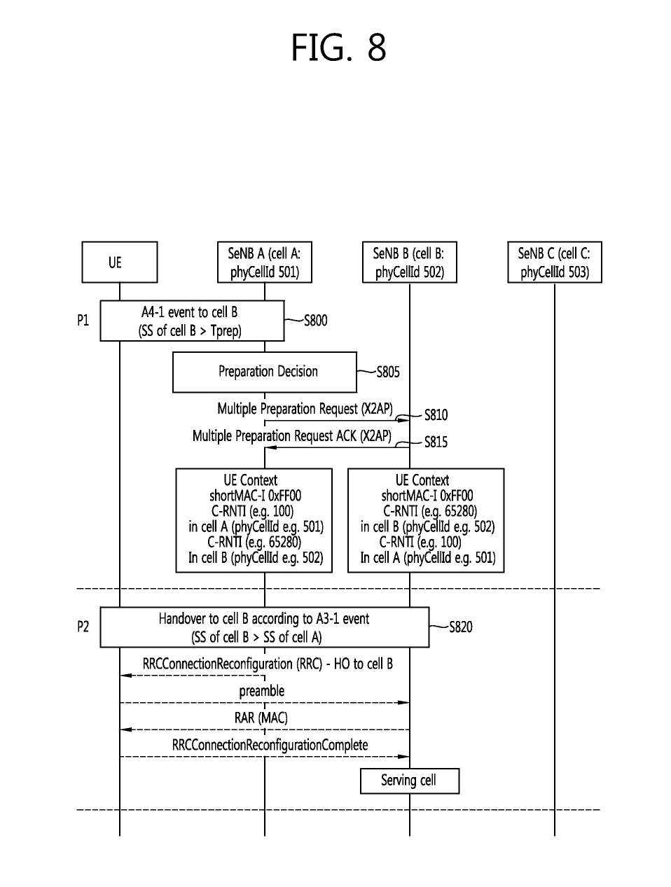

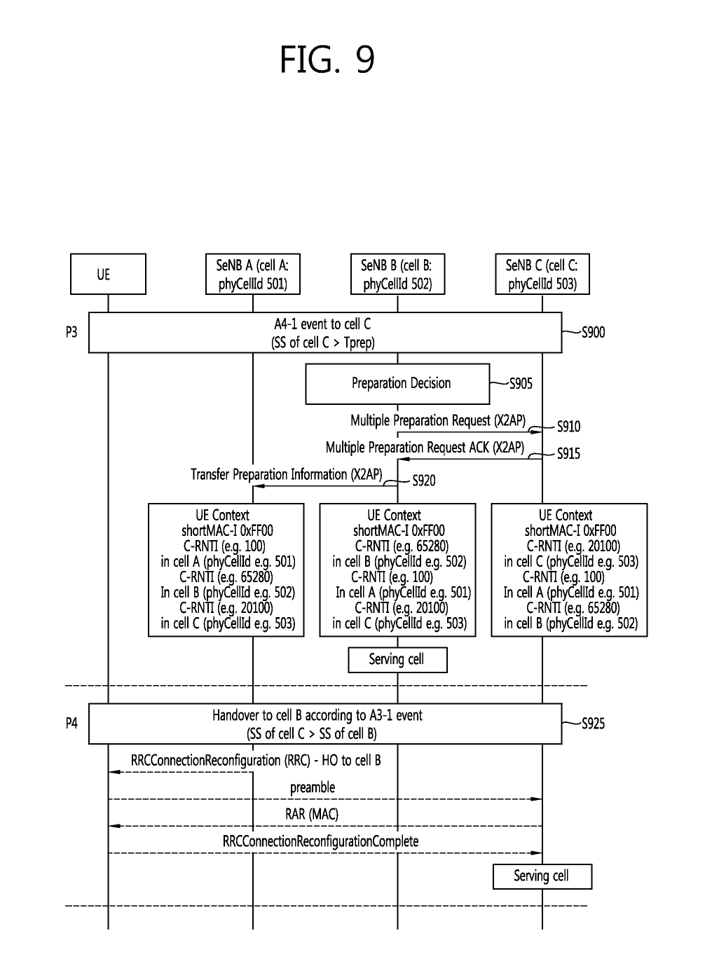

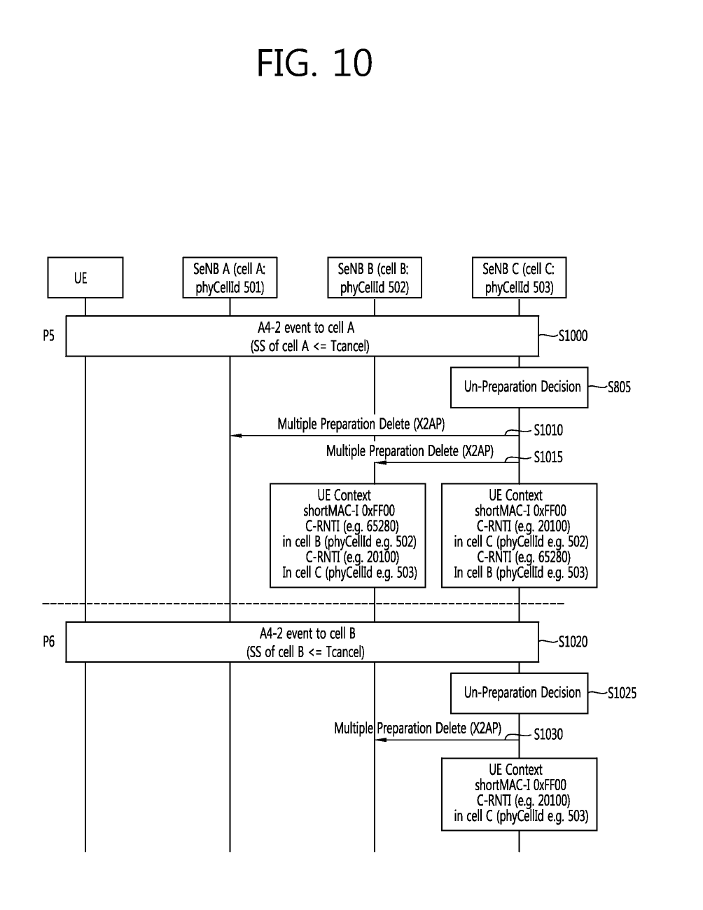

FIGS. 8 to 10 below illustrate examples of the MPM operation procedure according to the position of a UE in FIG. 6. Particularly, FIG. 8 illustrates the MPM operation procedure according to each event at positions P1 and P2 of a UE, FIG. 9 illustrates the MPM operation procedure according to each event at positions P3 and P4 of a UE, FIG. 10 illustrates the MPM operation procedure according to each event at positions P5 and P6 of a UE. In FIG. 8 to FIG. 10, it is assumed the case that the physical cell ID of cell A of eNB A is 501, the physical cell ID of cell B of eNB B is 502 and the physical cell ID of cell C of eNB C is 503. Herein, each of cell A, cell B and cell C may be called small cell A, small cell B and small cell C.

Referring to FIG. 8, in the situation that cell A is the serving cell, according to the measurement result at position P1 by a UE, the event A4-1 for cell B occurs (step, S800). This is the case in which the signal strength (SS) of cell B is greater than Tprep.

Small eNB A performs a preparation decision (step, S805), and transmits a multiple preparation request message to small eNB B (step, S810). The multiple preparation request message may be transmitted through the X2 interface (or X2AP).

The multiple preparation request message may include, for example, the parameter represented in Table 2 below.

TABLE 2
Reservation Information List
[0] Search ID: c-RNTI(100), phyCellId(501)

Change ID: NULL, NULL
X2AP Reservation Container: (RRC) RRCConnectionReconfiguration
for handover to cell A)

Table 2 include the list of information which is reserved (or stored), and c-RNTI 100 and phyCellId 501 in the search ID filed of item [0] represent to reserve (or store) the information that C-RNTI value of cell A whose physical cell ID is 501.

Small eNB B generates the UE context information in cell B, and transmits multiple preparation request ACK message to small eNB A (step, S815). The multiple preparation request ACK message may be transmitted through the X2 interface.

The multiple preparation request ACK message may include the parameter, for example, shown as in Table 3 as follows.

TABLE 3
Result Code: success or fail
Reservation Information List
[0] Search ID: c-RNTI(65280), phyCellId(502)

X2AP Reservation Container: (RRc) RRCConnectionReconfiguration
for handover to cell B)

Table 3 includes the result of the request and the list of the information that is reserved (or saved), the phyCellId502, the c-RNTI 65280 of the search ID filed of item [0] shows that the information is going to be reserved or saved that the value of C-RNTI of cell B whose physical cell ID is 502 is 65280.

In such an environment, both cell A and cell B save the UE context information for the corresponding UE. The UE context information may include the both C-RNTI in cell A (e.g. value 100) and C-RNTI in cell B (e.g. value 65280). When each cell is handed over to another cell, the RRC message (including the parameter related to RRC) made by another cell that is going to be transmitted to the UE is exchanged.

After that, in case that the UE moves to position P2, the handover procedure is performed to cell B according to the event A3-1 for cell B (step, S820). This is the case that the signal strength SS of cell B measured by the UE is bigger than that of cell A. More particularly, small eNB A transmits the RRC connection reconfiguration message including the command of handover to cell B to the UE. The UE transmits a random access preamble to small eNB B through RACH. The random access preamble may be one preamble that is randomly selected among the contention-based random access preambles. Small eNB B transmits the random access response (RAR) message to the UE. The UE, hereafter, transmits the RRC connection reconfiguration complete message to small eNB B. In this case, the serving cell for the corresponding UE is to be cell B.

Referring to FIG. 9, in case that the UE moves to position P3, the event A4-1 happens for cell C according to the measurement result of the UE (step, S900). This is the case that the signal strength SS of cell C is bigger than Tprep.

Small eNB B performs preparation decision (step, S905), and transmits multiple preparation request message to small eNB C (step, S910). The multiple preparation request message may be transmitted through the interface X2 (or X2AP).

The multiple preparation request message may include the parameter as shown in the following Table 4.

TABLE 4
Reservation Information List
[0] Search ID: c-RNTI(65280), phyCellId(502)

Change ID: NULL, NULL
X2AP Reservation Container: (RRC) RRCConnectionReconfiguration
for handover to cell B)

[1] Search ID: c-RNTI(100), phyCellId(501)

Change ID: NULL, NULL
X2AP Reservation Container: (RRC) RRCConnectionReconfiguration
for handover to cell A)

Table 4 includes the list of the information that is reserved (or saved), the phyCellId502, the c-RNTI 65280 of the search ID filed of item [0] shows that the information is going to be reserved (or saved) that the value of C-RNTI of cell B whose physical cell ID is 502 is 65280. Additionally, the phyCellId501, the c-RNTI 100 of the search ID filed of item [1] shows that the information is going to be reserved (or saved) that the value of C-RNTI of cell A whose physical cell ID is 501 is 100.

Small eNB C generates the UE context information in cell C and transmits the multiple preparation request ACK message to small eNB B (step, S915). The multiple preparation request ACK message may be transmitted through the interface X2.

The multiple request ACK message may include the parameter, for example, as shown in the following Table 5.

TABLE 5
Result Code: success or fail
Reservation Information List
[0] Search ID: c-RNTI(20100), phyCellId(503)

X2AP Reservation Container: (RRC) RRCConnectionReconfiguration
for handover to cell C)

Table 5 includes the result of the request and the list of the information that is reserved (or saved), the phyCellId503, the c-RNTI 20100 of the search ID filed of item [0] shows that the information is going to be reserved or saved that the value of C-RNTI of cell C whose physical cell ID is 503 is 20100.

Small eNB B performs the transmission of the preparation information to small eNB A (step, S920). The preparation information may be transmitted through the interface X2 and includes C-RNTI in cell C.

The preparation information to be transmitted, for example, may include the parameter as shown in Table 6 as below.

TABLE 6
Reservation Information List
[0] Search ID: c-RNTI(20100), phyCellId(503)

Change ID: NULL, NULL
X2AP Reservation Container: (RRC) RRCConnectionReconfiguration
for handover to cell C)

Table 6 includes the list of the information that is reserved (or saved), the phyCellId503, the c-RNTI 20100 of the search ID filed of item [0] shows that the information is going to be reserved (or saved) that the value of C-RNTI of cell C whose physical cell ID is 503 is 20100.

In such an environment, all of cell A, cell B, and cell C save the UE context information for the corresponding UE. The UE context information may include all the C-RNTI in cell A (e.g. value 100), C-RNTI in cell B (e.g. value 65280), and C-RNTI in cell C (e.g. value 20100). Each cell has the RRC message for the handover to the other two cells.

After that, in case that the UE moves to position P4, the handover procedure is performed to cell C according to the event A3-1 for cell C (step, S92). This is the case that the signal strength SS of cell C measured by the UE is bigger than that of cell B. More particularly, small eNB B transmits the RRC connection reconfiguration message including the command of handover to cell C to the UE. The UE transmits a random access preamble to small eNB C through RACH. The random access preamble may be one preamble that is randomly selected among the contention-based random access preambles. Small eNB C transmits the random access response (RAR) message to the UE. The UE, hereafter, transmits the RRC connection reconfiguration complete message to small eNB C. In this case, the serving cell for the corresponding UE is to be cell C.

Referring to FIG. 10, in case that the UE moves to position P5, the event A4-2 happens for cell A according to the measurement result of the UE (step, S1000). This is the case that the signal strength SS of cell A is smaller than Tcancel.

Small eNB C performs the un-preparation decision (step, S1005), and transmits the first multiple preparation delete message to small eNB A and small eNB B (step, S1010, S1015). The first multiple preparation delete message includes the message that commands cell A to be unprepared. The first multiple preparation delete message may be transmitted through the interface X2 (or X2AP).

The first multiple preparation delete message may include the parameter as shown in the following Table 7, for example.

TABLE 7

Cancellation Information List
[0] Search ID: c-RNTI(100), phyCellId(501)

Table 7 includes the list of the information that is deleted (or unprepared), the phyCellId501, the c-RNTI 100 of the search ID filed of item [0] shows that the information is going to be deleted (or unprepared) that the value of C-RNTI of cell A whose physical cell ID is 501 is 100.

In such an environment, cell A deletes the UE context information for the corresponding UE, and both cell B and cell C save the UE context information of which C-RNTI in cell A for the corresponding UE is deleted. Accordingly, the UE context information may include the both C-RNTI in cell B (e.g. value 65280) and C-RNTI in cell C (e.g. value 20100). In this case, when being handed over to another cell, cell B and cell C exchange the RRC message (including the parameter related to RRC) made by another cell that is going to be transmitted to the UE.

Hereinafter, in case that the UE moves to position P6, the event A4-2 for cell B happens according to the measurement result of the UE (step, S1020). This is the case that the signal strength SS of cell B is smaller than or equal to Tcancel.

Small eNB C performs the un-preparation decision (step, S1025) and transmits the second multiple preparation delete message to small eNB B (step, S1030). The second multiple preparation delete message includes the information that commands cell B to be unprepared. The second multiple preparation delete message may be transmitted through the interface X2 (or X2AP).

The second multiple preparation delete message, for example, may include the parameter as shown in the following Table 8.

TABLE 8

Cancellation Information List
[0] Search ID: c-RNTI(65280), phyCellId(502)

Table 8 includes the list of the information that is deleted (or unprepared), the phyCellId502, the c-RNTI 65280 of the search ID filed of item [0] shows that the information is going to be deleted (or unprepared) that the value of C-RNTI of cell B whose physical cell ID is 502 is 65280.

In such an environment, cell B deletes the UE context information for the corresponding UE, and cell C save the UE context information of which C-RNTI in cell B for the corresponding UE is deleted. Accordingly, the UE context information may include the C-RNTI in cell C (e.g. value 20100). That is, in the UE context information of cell C is left the information of cell C itself but not left the RRC parameter for the handover to another cell.

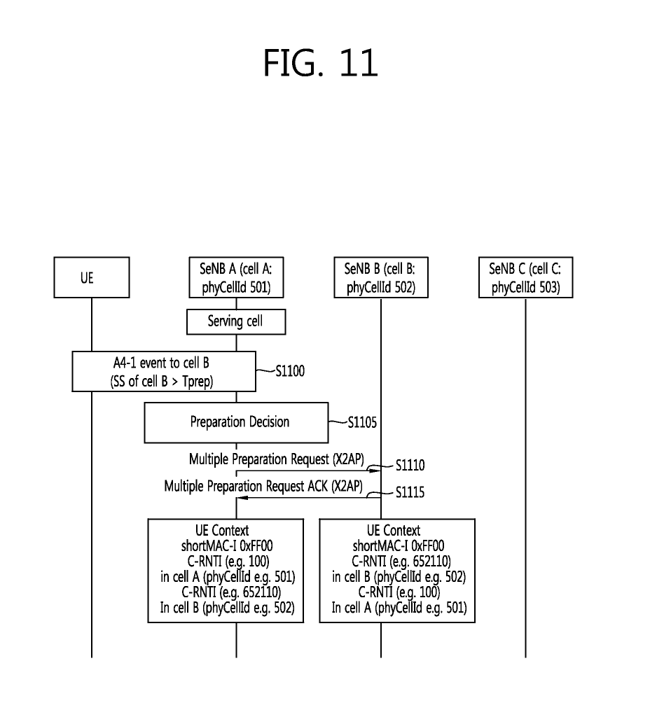

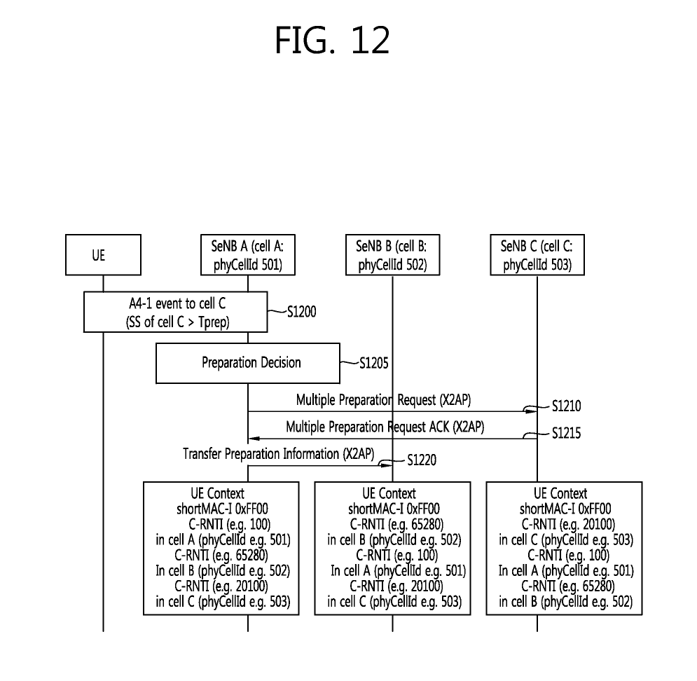

FIG. 11 and FIG. 12 illustrate an example of the preparation procedure according to the MPM of the present invention.

Referring to FIG. 11, in the state that cell A is a serving cell, the event A4-1 for cell B happens according to the measurement result of the UE (step, S1100). This is the case that the signal strength (SS) of cell B is bigger than Tprep.

Small eNB A performs the preparation decision (step, S1105) and transmits the multiple preparation request message to small eNB B (step, S1110). The multiple preparation request message may be transmitted through the interface X2 (or X2AP).

The multiple preparation request message may include the C-RNTI of cell A for the corresponding UE, and include the parameter as shown in the following Table 9, for example.

TABLE 9
Reservation Information List
[0] Search ID: c-RNTI(100), phyCellId(501)

Change ID: NULL, NULL
X2AP Reservation Container: (RRC) RRCConnectionReconfiguration
for handover to cell A)

Small eNB B generates the UE context information in cell B and transmits the multiple preparation request ACK message to small eNB A (step, S1115). The multiple preparation request ACK message may be transmitted through the interface X2.

The multiple preparation request ACK message may include the C-RNTI of cell B for the corresponding UE and include the parameter as shown in the following Table 10, for example.

TABLE 10
Result Code: success or fail
Reservation Information List
[0] Search ID: c-RNTI(65280), phyCellId(502)

X2AP Reservation Container: (RRC) RRCConnectionReconfiguration
for handover to cell B)

In such circumstances like this, cell A and cell B both save the UE context information for the corresponding UE. The UE context information may include both the C-RNTI in cell A (for example, value 100) and the C-RNTI in cell B (for example, value 65280). When being handed over to another cell, each cell exchanges the RRC message (including the parameter related to the RRC) made by another cell that is going to be transmitted to the UE.

Referring to FIG. 12, in the state that cell A is a still serving cell after FIG. 11, A4-1 event for cell B happens according to the measurement result of the UE (step, S1200). This is the case that the signal strength (SS) of cell C is bigger than Tprep.

Small eNB A performs the preparation decision (step, S1205), and transmits the multiple preparation request message to small eNB C (step, S1210). The multiple preparation request message may be transmitted through the interface X2 (or X2AP).

The multiple preparation request message may include the C-RNTI of cell A and the C-RNTI of cell B for the corresponding UE, and include the parameter as shown in the following Table 11, for example.

TABLE 11
Reservation Information List
[0] Search ID: c-RNTI(100), phyCellId(501)

Change ID: NULL, NULL
X2AP Reservation Container: (RRC) RRCConnectionReconfiguration
for handover to cell A)

[1] Search ID: c-RNTI(65280), phyCellId(502)

Change ID: NULL, NULL
X2AP Reservation Container: (RRC) RRCConnectionReconfiguration
for handover to cell B)

Small eNB C generates the UE context information in cell C and transmits the multiple preparation request ACK message to small eNB A (step, S1215). The multiple preparation request ACK message may be transmitted through the interface X2.

The multiple preparation request ACK message may include the C-RNTI of cell C for the corresponding UE and include the parameter as shown in the following Table 12, for example.

TABLE 12
Result Code: success or fail
Reservation Information List
[0] Search ID: c-RNTI(20100), phyCellId(503)

X2AP Reservation Container: (RRC) RRCConnectionReconfiguration
for handover to cell C)

Small eNB A performs the transmission of the preparation information to small eNB B (step, S1220). Herein, the preparation information may be transmitted through interface X2, and include the C-RNTI in cell C for the corresponding UE.

The preparation information to be transmitted, for example, may include the parameter as shown in the following Table 13.

TABLE 13
Reservation Information List
[0] Search ID: c-RNTI(20100), phyCellId(503)

Change ID: NULL, NULL
X2AP Reservation Container: (RRC) RRCConnectionReconfiguration
for handover to cell C)

In such circumstances like this, cell A, cell B, and cell C save the UE context information for the corresponding UE. The UE context information may include all of the C-RNTIs in cell A (for example, value 100), the C-RNTI in cell B (for example, value 65280) and the C-RNTI in cell C (for example, value 20100). Each cell may have the RRC message (RRC parameter) for the handover to the other two cells.

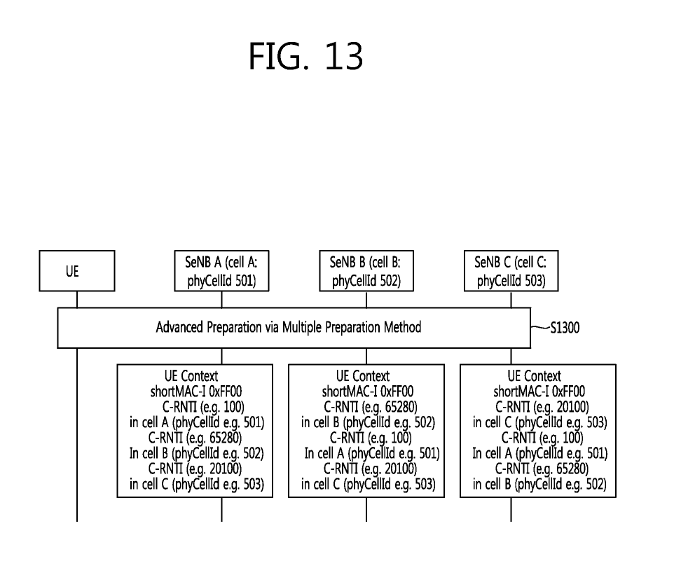

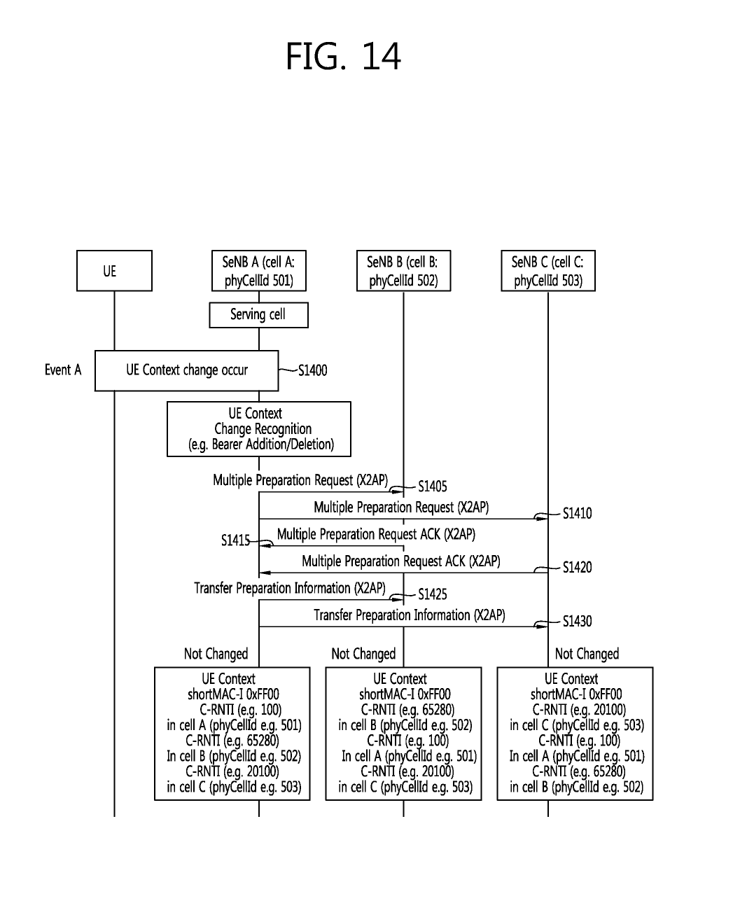

FIG. 13 and FIG. 14 illustrate an example of the preparation procedure according to the MPM of the present invention. FIG. 13 and FIG. 14 illustrate the procedure of updating the UE context information in other cells when the UE context information of the serving cell is changed in the state that three cells are all prepared.

Referring to FIG. 13, the UE and small eNB A, small eNB B, and small eNB C perform an advanced preparation procedure based on the MPM (step, S1300). In this case, small eNB A, small eNB B, and small eNB C may retain the UE context information respectively. The UE context information that is retained by each small eNB includes the C-RNTI for the UE in cell A, the C-RNTI for the UE in cell B, and the C-RNTI for the UE in cell C. That is, cell A, cell B, and cell C are the prepared cells. Each cell has the RRC message (RRC parameter) for the handover to the other two cells.

Referring to FIG. 14, the event A happens in the state that cell A is a serving cell after FIG. 13 and the UE context information of cell A is changed (step, S1400). For example, the UE context information may be changed according to the bearer addition/deletion in cell A. In this case, a series of procedures are performed in order to unify (or update) the UE context information of cell B and cell C with the changed UE context information of cell A as the center.

Small eNB A transmits the multiple preparation request message to small eNB B and small eNB C (step, S1405, S1410). The multiple preparation request message, for example, may include the parameter shown as in the following Table 14.

TABLE 14
Reservation Information List
[0] Search ID: c-RNTI(100), phyCellId(501)

Change ID: NULL, NULL
X2AP Reservation Container: (RRC) RRCConnectionReconfiguration
for handover to cell A)

Each of small eNB B and small eNB C transmits the multiple preparation request ACK message to small eNB A (step, S1415, S1420). The multiple preparation request ACK message that is transmitted from small eNB B and small eNB C may include the parameter as shown in each of the following Table 15 and Table 16, for example.

TABLE 15
Result Code: success or fail
Reservation Information List
[0] Search ID: c-RNTI(65280), phyCellId(502)

X2AP Reservation Container: (RRC) RRCConnectionReconfiguration
for handover to cell B)

TABLE 16
Result Code: success or fail
Reservation Information List
[0] Search ID: c-RNTI(20100), phyCellId(503)

X2AP Reservation Container: (RRC) RRCConnectionReconfiguration
for handover to cell C)

Small eNB A performs the transmission of the preparation information to small eNB B and small eNB C (step, S1425, 1430). The preparation information that is transmitted to eNB B and small eNB C may include the parameter as shown in each of the following Table 17 and Table 18, for example.

TABLE 17
Reservation Information List
[0] Search ID: c-RNTI(65280), phyCellId(502)

X2AP Reservation Container: (RRC) RRCConnectionReconfiguration
for handover to cell B)

TABLE 18
Reservation Information List
[0] Search ID: c-RNTI(20100), phyCellId(503)

X2AP Reservation Container: (RRC) RRCConnectionReconfiguration
for handover to cell C)

In this case, each of cell A, cell B and cell C may keep the UE context information which is changed (or updated). In addition, in this case, each cell may have the RRC message (the RRC parameter) for handover into the other two cells. Through the procedure described above, all of cell A, cell B and cell C may be prepared, and in this case, a UE is able to perform the RLF recovery to any cell of the three cells, also, is able to perform prompt handover (HO) to any cell. Herein, it is the same as described above that the multiple preparation request message, the multiple preparation request ACK message and the preparation information may be transmitted through the X2 interface (or X2AP).

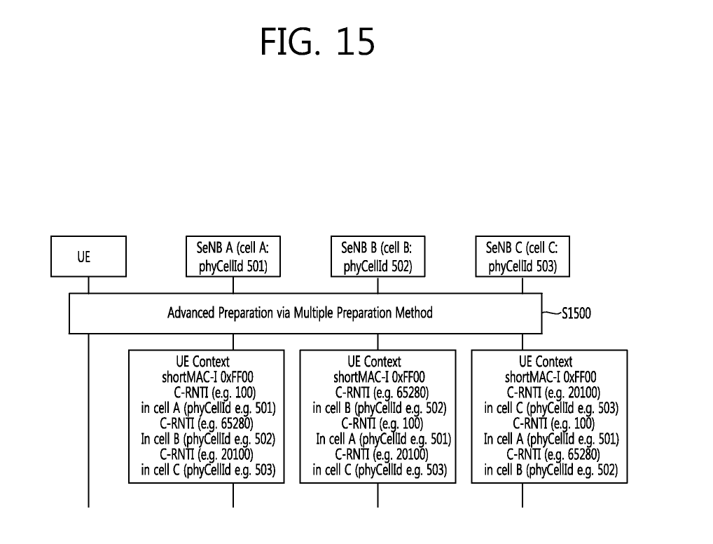

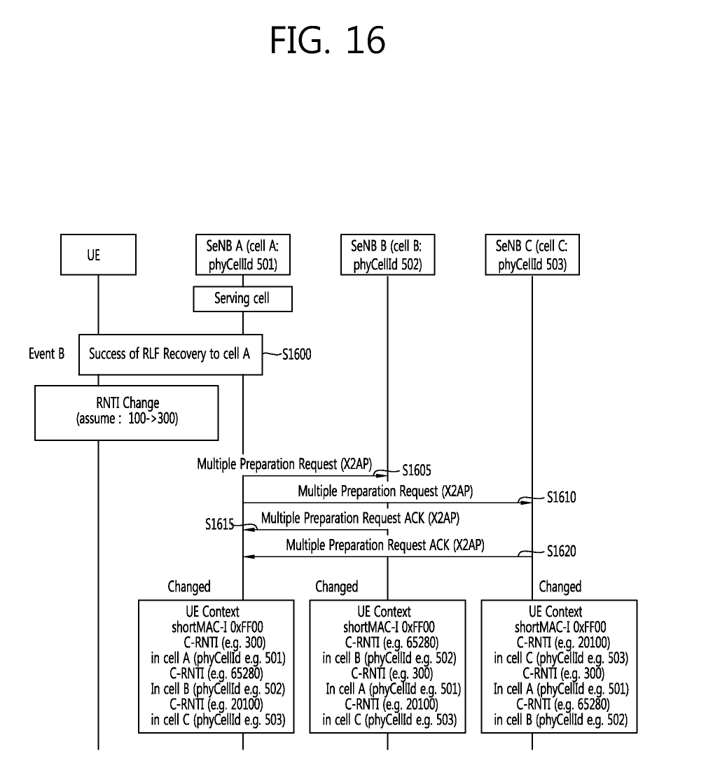

FIG. 15 and FIG. 16 illustrate still another example of the preparation procedure according to the MPM of the present invention. FIG. 15 and FIG. 16 show the procedure of updating the UE context information in the other cells, when the RLF recovery to the serving cell is successful and the UE context information is changed in the state that all of three cells are prepared.

Referring to FIG. 15, the UE, small eNB A, small eNB B and small eNB C perform the advanced preparation procedure based on the MPM (step, S1500). In this case, each of small eNB A, small eNB B and small eNB C may keep the UE context information. The UE context information that is kept by the small eNBs keep includes the C-RNTI for the UE in cell A, the C-RNTI for the UE in cell B and the C-RNTI for the UE in cell C. That is, cell A, cell B and cell C are the prepared cells. Each cell may have the RRC message (the RRC parameter) for handover to the other two cells.

Referring to FIG. 16, the RLF occurs in the state that cell A is the serving cell after the state of FIG. 15, and the RLF recovery to cell A is performed (step, S1600). In case the RLF recovery is successful (event B), the UE context information in cell A for the corresponding UE may be changed. For example, the C-RNTI of cell A for the corresponding UE, which is included in the UE context information, may be changed from value 100 to value 300. In this case, in order to unify the UE context information of cell B and cell C with the changed UE context information of cell A being centered, the following series of procedures are performed.

Small eNB A transmits the multiple preparation request message to small eNB B and small eNB C (steps, S1605 and S1610). The multiple preparation request message may include, for example, the parameters represented in following Table 19.

TABLE 19
Reservation Information List
[0] Search ID: c-RNTI(100), phyCellId(501)

Change ID: c-RNTI(300), phyCellId(501)
X2AP Reservation Container: (RRC) RRCConnectionReconfiguration
for handover to cell A)

Table 19 includes the list of the information being reserved (or stored), c-RNTI 300 and phyCellId 501 of the change ID field in section[0] represent that parameters c-RNTI 100 and phyCellId 501 are to be changed to c-RNTI 300 and phyCellId 501.

Through the multiple preparation request message, cell B and cell C may have the changed RRC message (the RRC parameter) for handover to cell A.

Each of Small eNB B and small eNB C transmits the multiple preparation request ACK message to small eNB A (steps, S1615 and S1620). The multiple preparation request ACK message which is transmitted from each of small eNB B and small eNB C may include, for example, the parameters represented in following Table 20 and Table 21.

TABLE 20

Result Code: success or fail
Reservation Information List
[0] Search ID: c-RNTI(65280), phyCellId(502)

X2AP Reservation Container: (RRC) NULL

TABLE 21

Result Code: success or fail
Reservation Information List
[0] Search ID: c-RNTI(20100), phyCellId(503)

X2AP Reservation Container: (RRC) NULL

In this case, each of cell A, cell B and cell C may keep the UE context information which is changed (or updated). In addition, in this case, each cell may have the RRC message (the RRC parameter) for handover into the other two cells. Through the procedure described above, all of cell A, cell B and cell C may be prepared, and in this case, a UE is able to perform the RLF recovery to any cell of the three cells, also, is able to perform prompt handover (HO) to any cell. Herein, it is the same as described above that the multiple preparation request message, the multiple preparation request ACK message and the preparation information may be transmitted through the X2 interface (or X2AP).

Method 2: The UE Mobility Management Method Based on the Context Fetch Method (CFM)

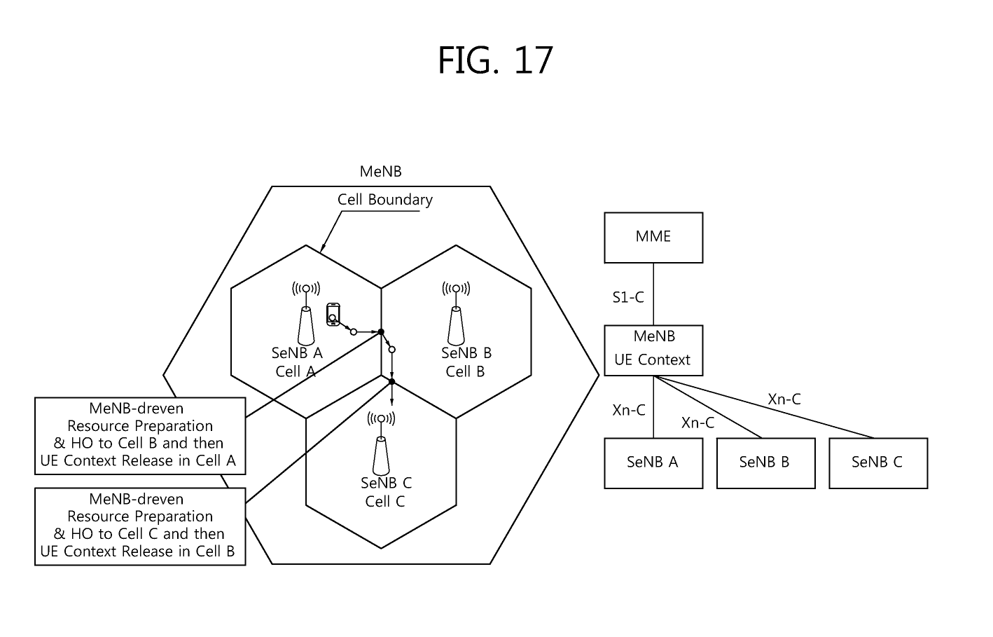

FIG. 17 illustrates a conceptual diagram for the CFM according to another embodiment of the present invention.

Referring to FIG. 17, the dense small cells may constitute at least one small cell cluster. The at least one small cell cluster may be managed by at least one master eNB. That is, under the assumption that there is a master eNB that manages the dense small cell cluster, the CFM has the structure of managing the UE context information in the master eNB. The cell of the master eNB may be a macro eNB (MeNB). According to the CFM, when a UE tries the RLF recovery to the small cell which is managed by the master eNB, the small eNB that operates the corresponding small cell may request the UE context information from the master eNB and carry. Accordingly, the CFM may further increase the possibility of the RLF recovery in comparison with the method according to current standard. In addition, when it is compared to the MPM, in the aspect of consistency of the UE context information in all cells which are prepared by the change of the UE context information, the RLF, and the like, the signaling overhead is decreased in case of the CFM. Meanwhile, the master eNB that manages the small cell cluster and the small eNBs that operates the corresponding small cells may be connected by an ideal backhaul or a non-ideal backhaul. In case that the master eNB and the small eNBs are connected by the non-ideal backhaul, the prompt RLF recovery such as the MPM may not performed since the delay that occurs when fetching the UE context information. In addition, such a CFM is hard to be applied when there is no macro eNB. Of course, even if allowing the signaling load such as the MPM, if the preparation (that is, the UE context information) is set up in the small eNBs and the UE context information is updated in the small eNBs when trying every RLF recovery, the prompt handover and RLF recovery may be performed. This will be described below by dividing CFM A method and CFM B method.

Although the possibility of RLF recovery to small cell is increased by introducing the CFM, it is required to design the protocol standard for Xn-C which is Xn interface on the Control Plane for connecting the master eNB and the small eNBs. In addition, S1-U (GTP (GPRS Tunneling Protocol)-U) on the User Plane may be used or Xn-U which is Xn interface on a new User Plane may be introduced. Hereinafter, the Xn interface may include Xn-C and Xn-U.

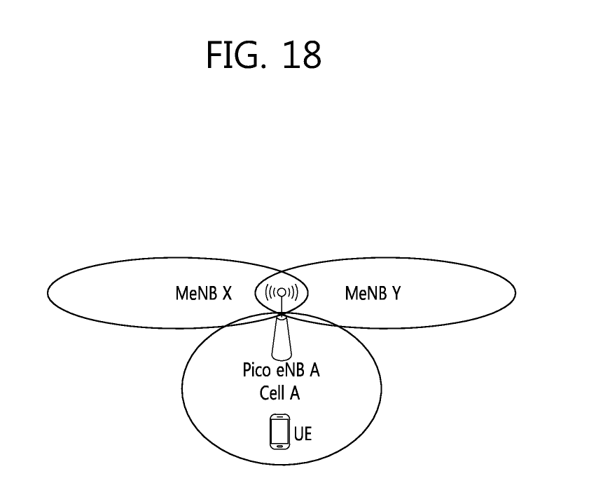

FIG. 18 illustrates a problem that occurs when performing the RLF recovery to a small cell according to the CFM.

Referring to FIG. 18, on the boundary where macro cell X of macro eNB X (MeNB X) and macro cell Y of macro eNB Y (MeNB Y) are overlapped, a small cell (here, Pico cell A of Pico eNB A) is disposed, and a UE is positioned at the corresponding Pico eNB A. When the UE tries to perform the RLF recovery to Pico cell A, Pico eNB A should know if it is possible to get the UE context information from MeNB X or get the UE context information from MeNB Y. The RLF occurs in the MeNB and the RLF recovery is progressed in the corresponding MeNB itself, or in the situation such as the handover between MeNBs, through a proper Mn—C, it is required to find the MeNB which is to perform the UE context information patch for the corresponding UE.

Hereinafter, the UE mobility management methods according to the CFM of the present invention are suggested.

### First Embodiment

### CFM A

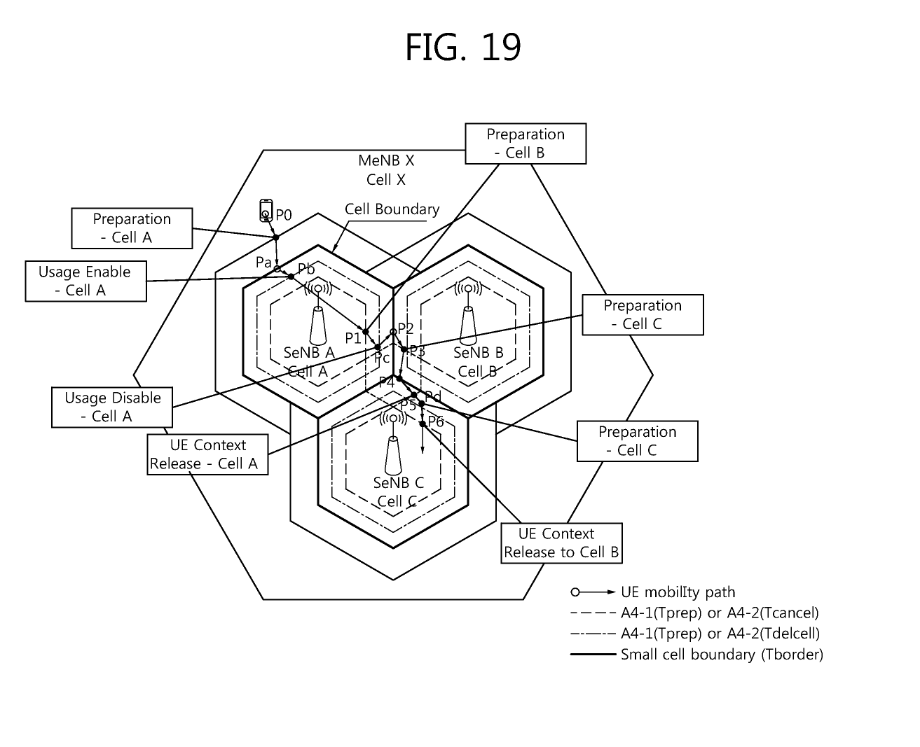

FIG. 19 illustrates an example of the mobility path of a UE.

Referring to FIG. 19, in the network environment that small cells (cell A, cell B and cell C) exist with being partially overlapped each other within a macro cell (cell X), a UE may sequentially move from position P0 to Pa, Pb, P1, Pc, P2, P3, P4, P5, Pd and P6. Cell X is operated by macro eNB X (MeNB X), and cell A, cell B and cell C are operated by small eNB A (SeNB A), small eNB B (SeNB B) and small eNB C (SeNB) C, respectively.

The dotted lines in FIG. 19 show boundaries for the preparation and release of each cell. For example, in case a UE enters into the inside the dotted line, it may be considered that the measurement result of the corresponding cell satisfies a predetermined threshold value Tprep for the preparation (the event A4-1). In case that a UE moves out of the dotted line of a cell, it may be considered that the corresponding cell satisfies the threshold value Tcancel for the cancel (or release) for the preparation (the event A4-2).

Also, the alternate long and short dash lines show boundaries for the addition and deletion of each cell. For example, in case a UE enters into the alternate long and short dash line, it may be considered that the measurement result of the corresponding cell satisfies a predetermined threshold value Taddcell for the adding cell (the event A4-1). In case that a UE moves out of the alternate long and short dash line, it may be considered that the measurement result of the corresponding cell satisfies a predetermined threshold value Tdelcell for the releasing cell (the event A4-2).

The small cell boundary may be determined based on the threshold value Tborder.

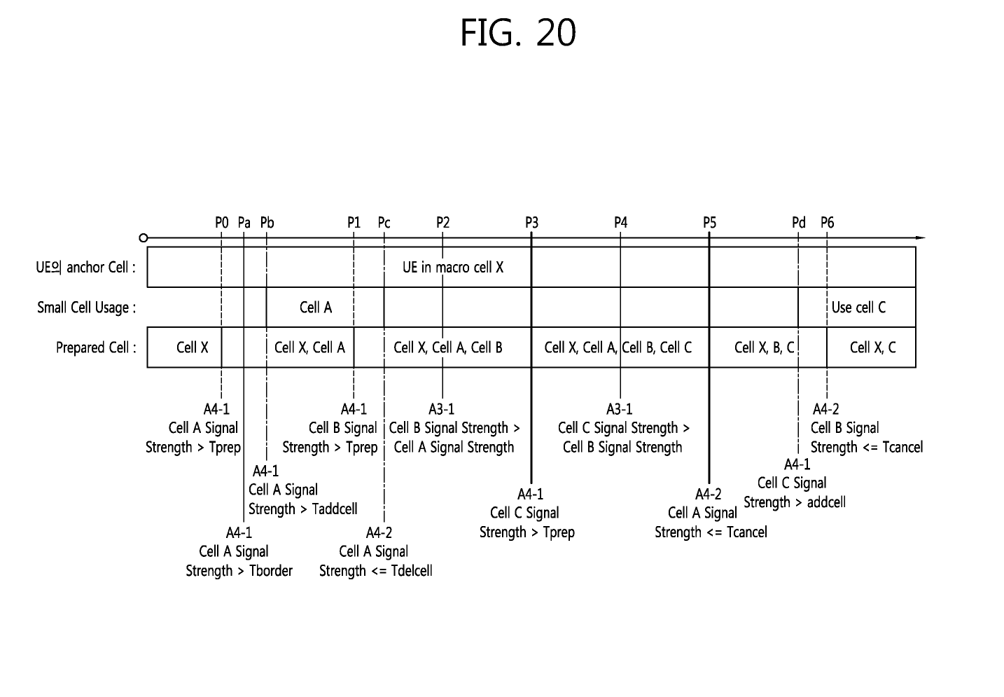

FIG. 20 illustrates examples of the event that occurs according to the position of a UE in FIG. 19. FIG. 20 shows, particularly, which event occurs for the position on the moving path of a UE. According to FIG. 20, it is shown that the anchor cell (that is, the cell which is connected all the time) is comprised of cell X (macro cell X), and the mobility of a UE is how to be managed for the event according to each position of the UE.

Referring to FIG. 20, initially, the serving cell and the prepared cell for a UE is cell X.

In case that a UE moves to P0 and the signal strength of cell A exceeds Tprep (the event A4-1), cell A as well as cell B become the prepared cells.

In case that a UE moves to Pa and the signal strength of cell A exceeds Tborder (the event A4-1), it is interpreted that the UE enters within the boundary of cell A.

In case that a UE moves to Pb and the signal strength of cell A exceeds Taddcell (the event A4-1), the addition of cell A (cell A is usable) is determined.

In case that a UE moves to P1 and the signal strength of cell A exceeds Tprep (the event A4-1), cell X, cell A and cell B are the prepared cells.

In case that a UE moves to Pc and the signal strength of cell A is smaller or the same as Tdellcell (the event A4-2), the deletion of cell A (cell A is not usable) is determined.

In case that a UE moves to P3 and the signal strength of cell A exceeds Tprep (the event A4-1), cell X, cell A, cell B and cell C are the prepared cells.

In case that a UE moves to P5 and the signal strength of cell A is smaller or the same as Tcancel (the event A4-2), cell A cancels (or releases) the preparation, and only cell X, cell B and cell C are the prepared cells.

In case that a UE moves to Pd and the signal strength of cell A exceeds Taddcell (the event A4-1), the addition of cell C (cell C is usable) is determined.

In case that a UE moves to P6 and the signal strength of cell A is smaller or the same as Tcancel (the event A4-2), cell B cancels (or releases) the preparation, and only cell X and cell C are the prepared cells.

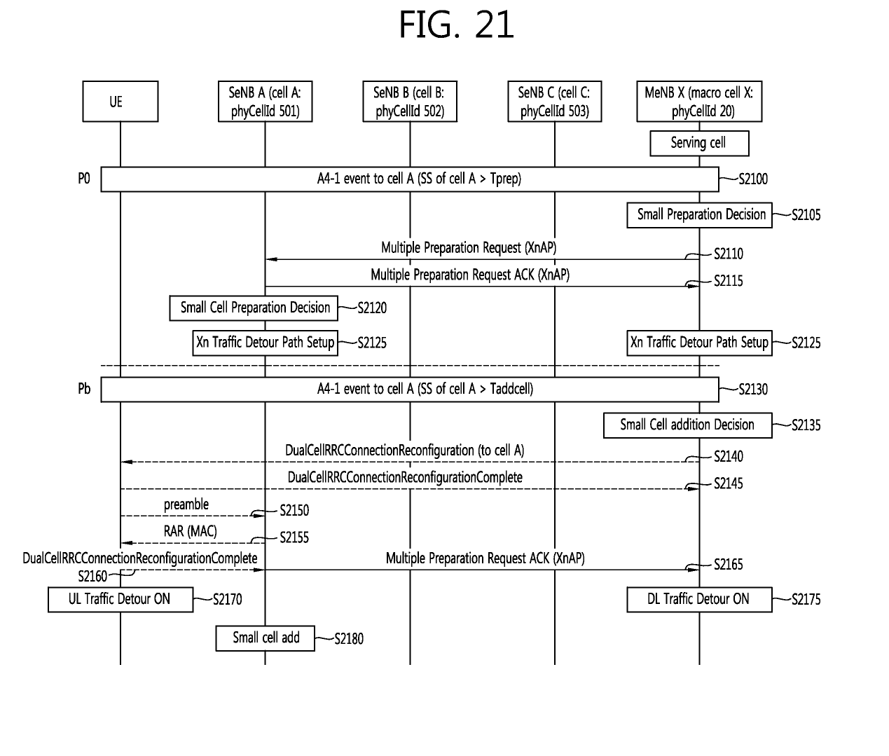

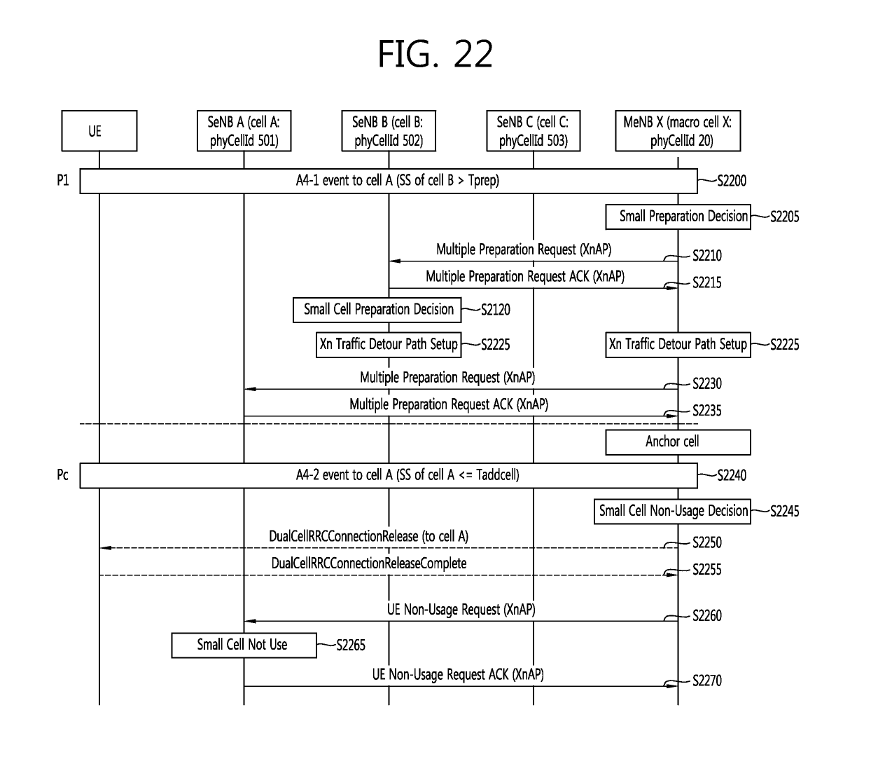

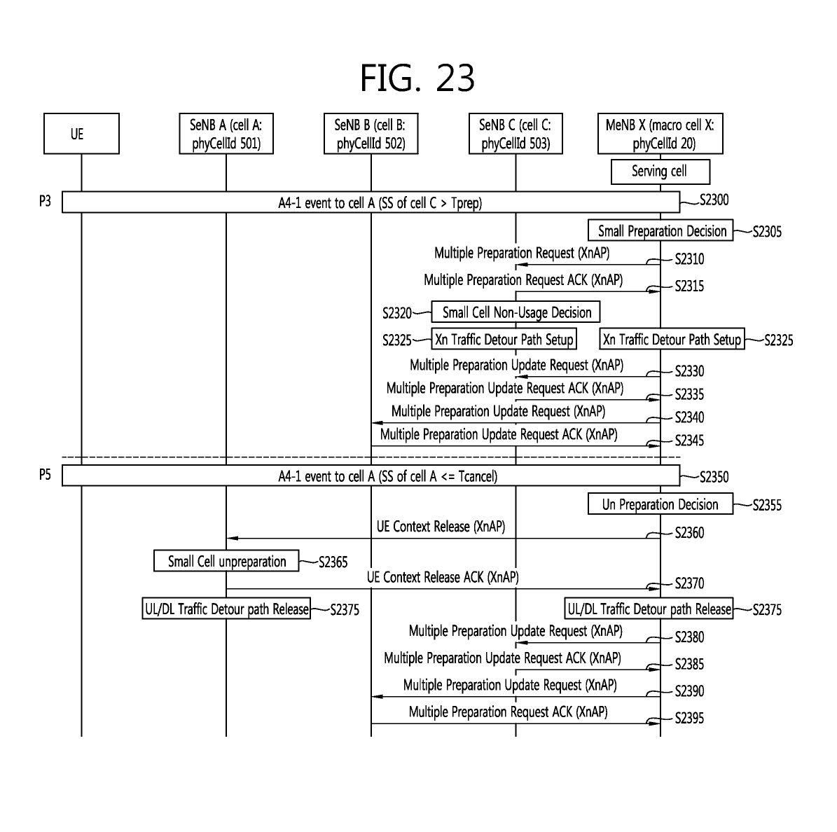

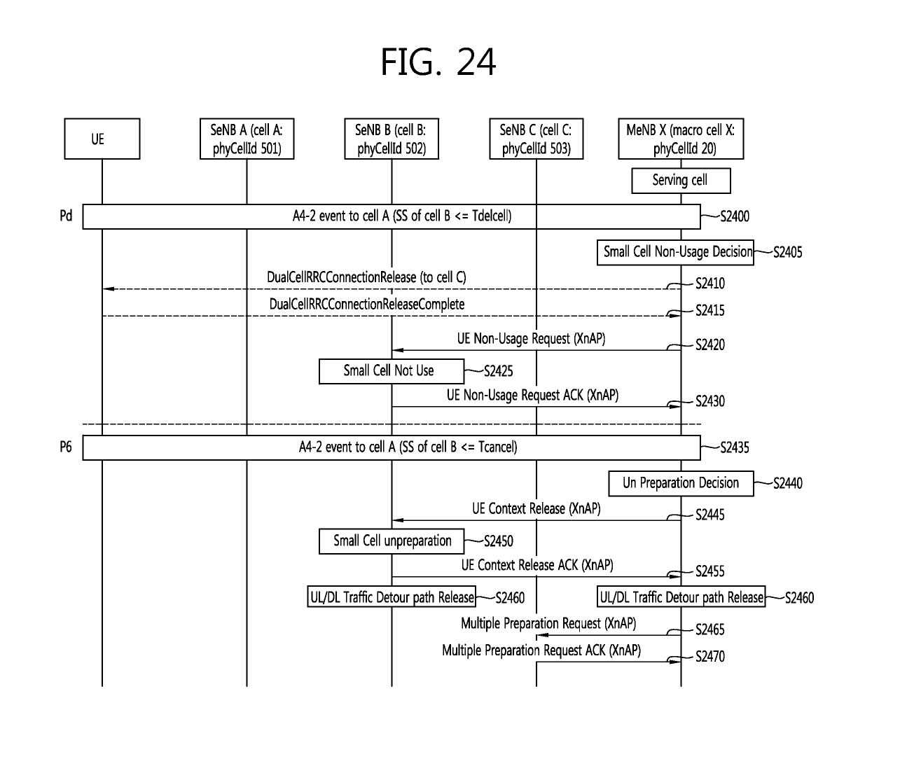

FIG. 21 to FIG. 24 below illustrates an example of the CFM operation procedure according to the position of a UE in FIG. 19. Particularly, FIG. 21 illustrates the CFM operation procedure according to each event in position P0 and Pa of a UE, FIG. 22 illustrates the CFM operation procedure according to each event in position P1 and Pc of a UE, FIG. 23 illustrates the CFM operation procedure according to each event in position P3 and P5 of a UE, and FIG. 24 illustrates the CFM operation procedure according to each event in position Pd and P6 of a UE. In FIG. 21 to FIG. 24, it is assumed the case that the physical cell ID of cell A of small eNB A is 501, the physical cell ID of cell B of small eNB B is 502, the physical cell ID of cell C of small eNB C is 503 and the physical cell ID of cell X of macro eNB X is 20. Herein, cell A, cell B and cell C may be called small cell A, small cell B and small cell C, respectively, and cell X may be called macro cell X.

First of all, referring to FIG. 21, in the state that cell X is the serving cell, according to the measurement result on position P0 of a UE, the event A4-1 for the case that the signal strength (SS) of cell A is greater than Tprep occurs (step, S2100).

Macro eNB X performs the preparation decision to cell A (step, S2105), and transmits the multiple preparation request message to small eNB A (step, S2110).

Small eNB A transmits the multiple preparation request ACK message to macro eNB X (step, S2115), and performs the preparation for cell A (step, S2120). The multiple preparation request message and the multiple preparation request ACK message may be transmitted through the Xn interface (or Xn Application Protocol (XnAP)).

The detour two-way path is set up for the Xn-U between macro eNB X and small eNB A (that is, Xn traffic path) (step, S2125).

Later, in case that the UE moves to position Pb, according to the measurement result of the UE, the event A4-1 for the case that the signal strength (SS) of cell A is greater than Taddcell occurs (step, S2130).

Macro eNB X performs the small cell addition decision (step, S2135), and transmits the Dual Cell RRC Connection Reconfiguration message for cell A to the UE (step, S2140).

The UE transmits the Dual Cell RRC Connection Reconfiguration Complete message to macro eNB X (step, S2145). In this case, the UE may transmit the Dual Cell RRC Connection Reconfiguration Complete message to small eNB A as well as to macro eNB X (not shown).

The UE transmits the random access preamble for the random access procedure to small eNB A through the RACH (step, S2150). Small eNB B transmits the random access response (RAR) message to the UE (step, S2155). Later, the UE transmits the RRC connection reconfiguration complete message to small eNB A (step, S2160). Small eNB A transmits the multiple preparation request ACK message to macro eNB X (step, S2165). The multiple preparation request ACK message may be transmitted through the Xn interface (or Xn Application Protocol (XnAP)). In this case, the UE may set up the uplink traffic detour ON (step, S2170), and macro eNB X may set up the downlink traffic detour ON (step, S2175). For example, in this case, the downlink packet may be transmitted to the UE through cell A, and the uplink packet may be transmitted macro eNB X through cell A.

Small eNB A performs the cell A addition procedure for the corresponding UE (step, S2180).

Through the procedures described above, macro eNB X may transmit or receive the whole or a part of the uplink/downlink packet for the UE through cell X, and small eNB A may transmit or receive the whole or a part of the uplink/downlink packet for the UE through cell A.

Later, referring to FIG. 22, in case that a UE moves to position P1, according to the measurement result of the UE, the event A4-1 for the case that the signal strength of cell B is greater than Tprep occurs (step, S2200).

Macro eNB X performs the preparation decision for cell B (step, S2205), and transmits the multiple preparation request message to small eNB B (step, S2210).

Small eNB B transmits the multiple preparation request ACK message to macro eNB X (step, S2215), and performs the preparation for cell B (step, S2220). The multiple preparation request message and the multiple preparation request ACK message may be transmitted through the Xn interface (or XnAP).

Macro eNB X and small eNB B set up the detour two-way path for the Xn-U (step, S2225).

Macro eNB X transmits the multiple preparation update request message to small eNB A in order to update the UE context information for cell C in cell A (step, S2230), and small eNB A transmits the multiple preparation update request ACK message to macro eNB X (step, S2235). The multiple preparation update request message and the multiple preparation update request ACK message may be transmitted through the Xn interface (or XnAP).

Later, in case that the UE moves to position Pc, according to the measurement result of the UE, the event A4-2 for the case that the signal strength of cell A is as the same or smaller than Tdelcell occurs (step, S2240).

Macro eNB X performs the small cell non-usage decision for cell A (step, S2245). The small cell non-usage decision may be called the small cell deletion decision.

Macro eNB X transmits the Dual Cell RRC Connection Release message for cell A to the UE (step, S2250). Through this, macro eNB X may notify that the resource of cell A is not usable to the UE.

The UE transmits the Dual Cell RRC Connection Release Complete message to macro eNB X (step, S2255). The Dual Cell RRC Connection Release message and the Dual Cell RRC Connection Release Complete message may be transmitted through the Xn interface (or XnAP).

Macro eNB X transmits the UE Non-Usage Request message to small eNB A (step, S2260). Through this, macro eNB X may notify that it does not provide service to the UE to small eNB A through cell A.

Small eNB A sets up the cell A non-usage for the corresponding UE (step, S2265), and transmits the UE Non-Usage Request ACK message to macro eNB X (step, S2270). The UE Non-Usage Request message and the UE Non-Usage Request ACK message may be transmitted through the Xn interface (or XnAP).

Later, referring to FIG. 23, in case that a UE moves to position P3, according to the measurement result of the UE, the event A4-1 for the case that the signal strength of cell C is greater than Tprep occurs (step, S2300).

Macro eNB X performs the preparation decision for cell C (step, S2305), and transmits the multiple preparation request message to small eNB C (step, S2310).

Small eNB C transmits the multiple preparation request ACK message to macro eNB X (step, S2315), and performs the preparation for cell C (step, S2320). The multiple preparation request message and the multiple preparation request ACK message may be transmitted through the Xn interface (or XnAP).

Macro eNB X and small eNB C set up the detour two-way path for the Xn-U (step, S2325).

In order to update the UE context information for cell C to cell A and cell B, macro eNB X transmits the multiple preparation update request to small eNB A and small eNB B (steps, S2330 and S2340), and small eNB A and small eNB B transmit the Multiple Preparation Update ACK Request to macro eNB X (steps, S2335 and S2345). The multiple preparation update request and the multiple preparation update request may be transmitted through the Xn interface (or XnAP).

Later, in case that the UE moves to position P5, according to the measurement result of the UE, the event A4-2 for the case that the signal strength of cell A is as the same or smaller than Tcancel occurs (step, S2350).

Macro eNB X performs the un-preparation decision for cell A (step, S2355), and transmits the UE context release message to small eNB A (step, S2360).

Small eNB A performs the small cell un-preparation for cell A based on the UE context release message (step, S2365), and transmits the UE context release ACK message to macro eNB X (step, S2370). The UE context release message and the UE context release ACK message may be transmitted through the Xn interface (or XnAP).

Macro eNB X and small eNB A release the detour two-way path for the Xn-U (step, S2375).

Macro eNB X transmits the multiple preparation update request message to small eNB B and small eNB C in order to update the related information according to the preparation release of cell A to cell B and cell C (steps, S2380 and S2390), and small eNB B and small eNB C transmit the multiple preparation update request ACK message to macro eNB X (steps, S2385 and S2395).

Later, referring to FIG. 24, in case that the UE moves to position Pd, according to the measurement result of the UE, the event A4-2 for the case that the signal strength of cell B is as the same or smaller than Tdelcell occurs (step, S2400).

Macro eNB X performs the small cell non-usage decision for cell B (step, S2405).

Macro eNB X transmits the Dual Cell RRC Connection Release message for cell B to the UE (step, S2410). Through this, macro eNB X may notify that the resource of cell B is not usable to the UE.

The UE transmits the Dual Cell RRC Connection Release Complete message to macro eNB X (step, S2415). The Dual Cell RRC Connection Release message and the Dual Cell RRC Connection Release Complete message may be transmitted through the Xn interface (or XnAP).

Macro eNB X transmits the UE Non-Usage Request message to small eNB B (step, S2420). Through this, macro eNB X may notify that it does not provide service to the UE to small eNB A through cell B.

Small eNB B sets up the cell B non-usage for the corresponding UE (step, S2425), and transmits the UE Non-Usage Request ACK message to macro eNB X (step, S2430).

The UE Non-Usage Request message and the UE Non-Usage Request ACK message may be transmitted through the Xn interface (or XnAP).

Later, in case that the UE moves to position P6, according to the measurement result of the UE, the event A4-2 for the case that the signal strength of cell B is as the same or smaller than Tcancel occurs (step, S2435).

Macro eNB X performs the un-preparation decision for cell A (step, S2440), and transmits the UE context release message to small eNB B (step, S2445).

Small eNB B performs the small cell un-preparation for cell B based on the UE context release message (step, S2450), and transmits the UE context release ACK message to macro eNB X (step, S2455). The UE context release message and the UE context release ACK message may be transmitted through the Xn interface (or XnAP).

Macro eNB X and small eNB B release the detour two-way path for the Xn-U (step, S2460).

Macro eNB X transmits the multiple preparation update request message to small eNB C in order to update the related information according to the preparation release of cell B (step, S2465), and small eNB C transmits the multiple preparation update request ACK message to macro eNB X (step, S2470). The multiple preparation update request message and the multiple preparation update request ACK message may be transmitted through the Xn interface (or XnAP).

### Second Embodiment

### CFM B

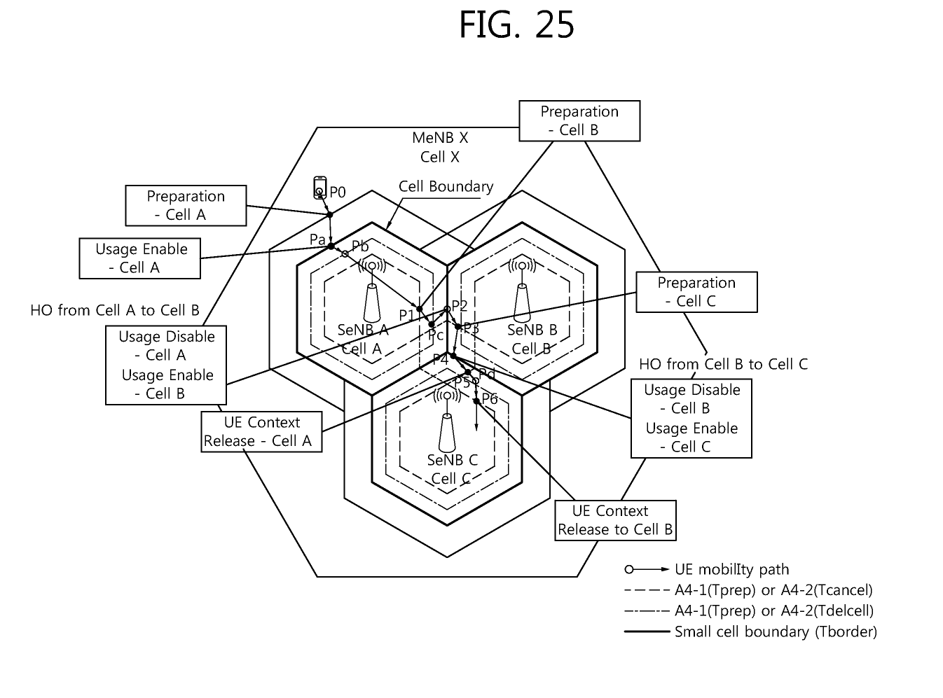

FIG. 25 illustrates another example of the mobility path of a UE.

Referring to FIG. 25, in the network environment that small cells (cell A, cell B and cell C) exist with being partially overlapped each other within a macro cell (cell X), a UE may sequentially move from position P0 to Pa, Pb, P1, Pc, P2, P3, P4, P5, Pd and P6. Cell X is operated by macro eNB X (MeNB X), and cell A, cell B and cell C are operated by small eNB A (SeNB A), small eNB B (SeNB B) and small eNB C (SeNB) C, respectively. The dotted lines in FIG. 19 show boundaries for the preparation and release of each cell. For example, in case a UE enters into the inside the dotted line, it may be considered that the measurement result of the corresponding cell satisfies a predetermined threshold value Tprep for the preparation (the event A4-1). In case that a UE moves out of the dotted line of a cell, it may be considered that the corresponding cell satisfies the threshold value Tcancel for the cancel (or release) for the preparation (the event A4-2).

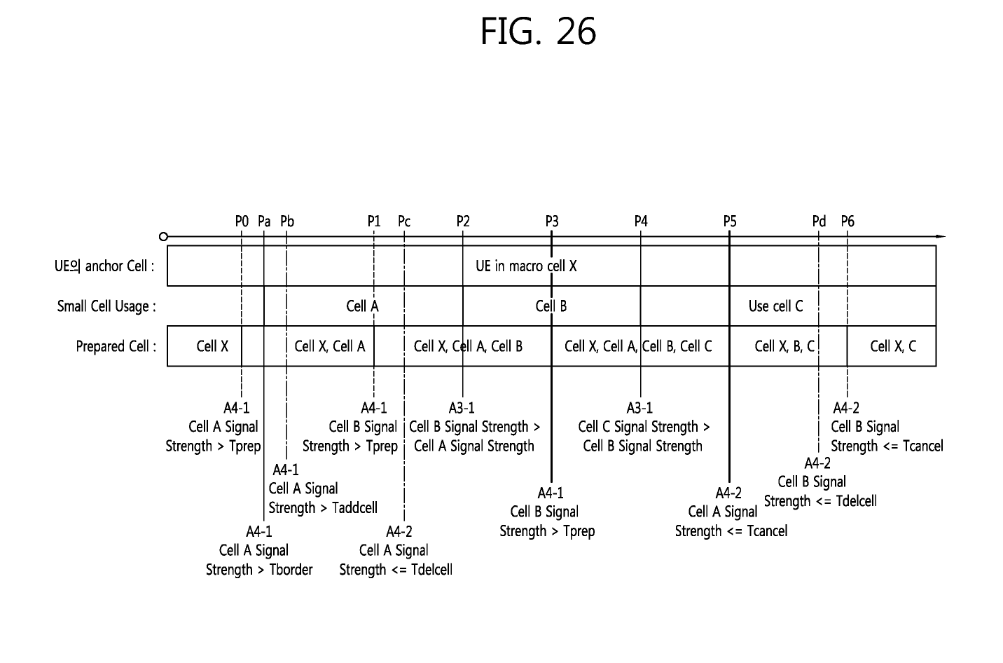

FIG. 26 illustrates examples of the event that occurs according to the position of a UE in FIG. 15. FIG. 26 shows, particularly, which event occurs for the position on the moving path of a UE. According to FIG. 26, it is shown that the anchor cell (that is, the cell which is connected all the time) is comprised of cell X (macro cell X), and the mobility of a UE is how to be managed for the event according to each position of the UE.

Referring to FIG. 26, initially, the serving cell and the prepared cell for a UE is cell X.

In case that a UE moves to P0 and the signal strength of cell A exceeds Tprep (the event A4-1), cell A as well as cell B become the prepared cells.

In case that a UE moves to Pa and the signal strength of cell A exceeds Tborder (the event A4-1), the addition of cell A (cell A is usable) is determined.

In case that a UE moves to P1 and the signal strength of cell B exceeds Tprep (the event A4-1), cell X, cell A and cell B are the prepared cells.

In case that a UE moves to P2 and the signal strength of cell B is greater than the signal strength of cell A (the event A3-1), the small cell handover from cell A to cell B for the UE is performed.

In case that a UE moves to P3 and the signal strength of cell C exceeds Tprep (the event A4-1), cell X, cell A, cell B and cell C are the prepared cells.

In case that a UE moves to P4 and the signal strength of cell C is greater than the signal strength of cell B (the event A3-1), the small cell handover from cell B to cell C for the UE is performed.

In case that a UE moves to P5 and the signal strength of cell A is smaller or the same as Tcancel (the event A4-2), cell A cancels (or releases) the preparation, and only cell X, cell B and cell C are the prepared cells.

In case that a UE moves to P6 and the signal strength of cell B is smaller or the same as Tcancel (the event A4-2), cell B cancels (or releases) the preparation, and only cell X and cell C are the prepared cells.

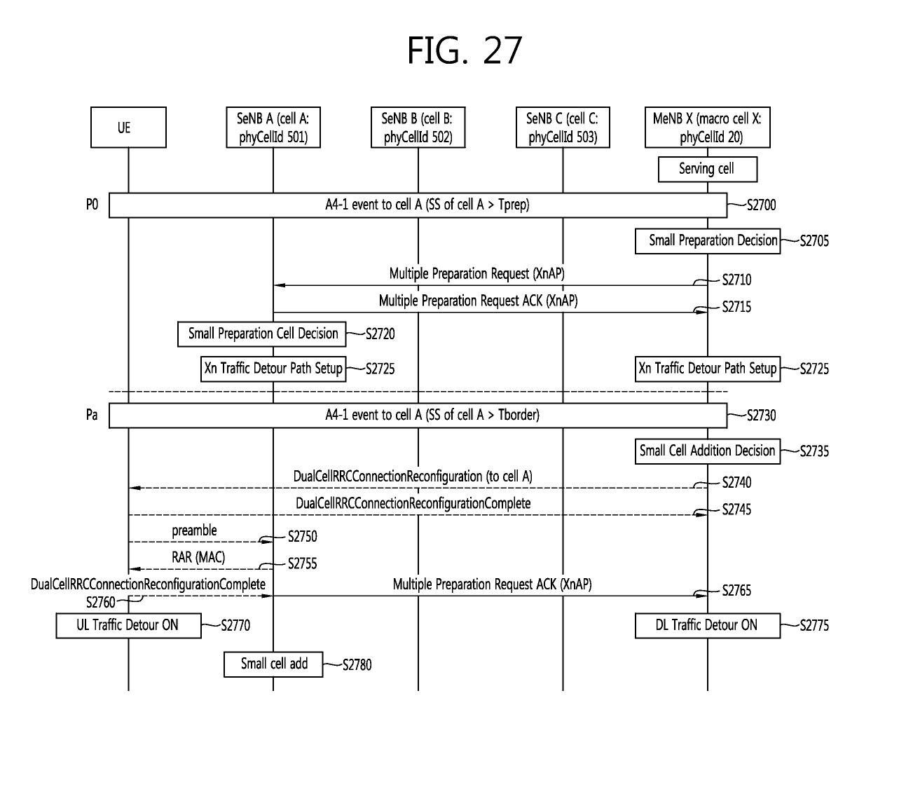

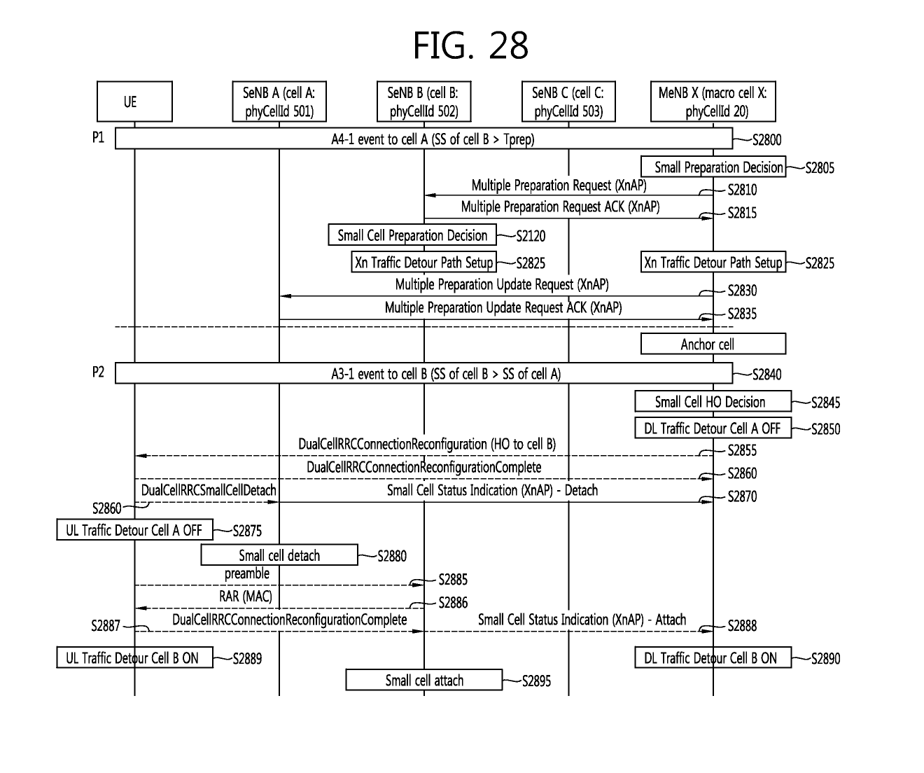

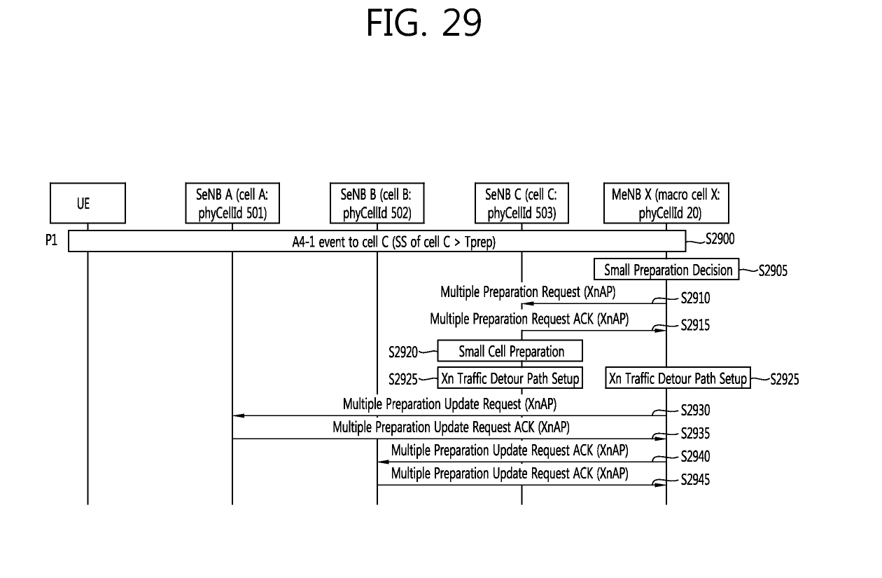

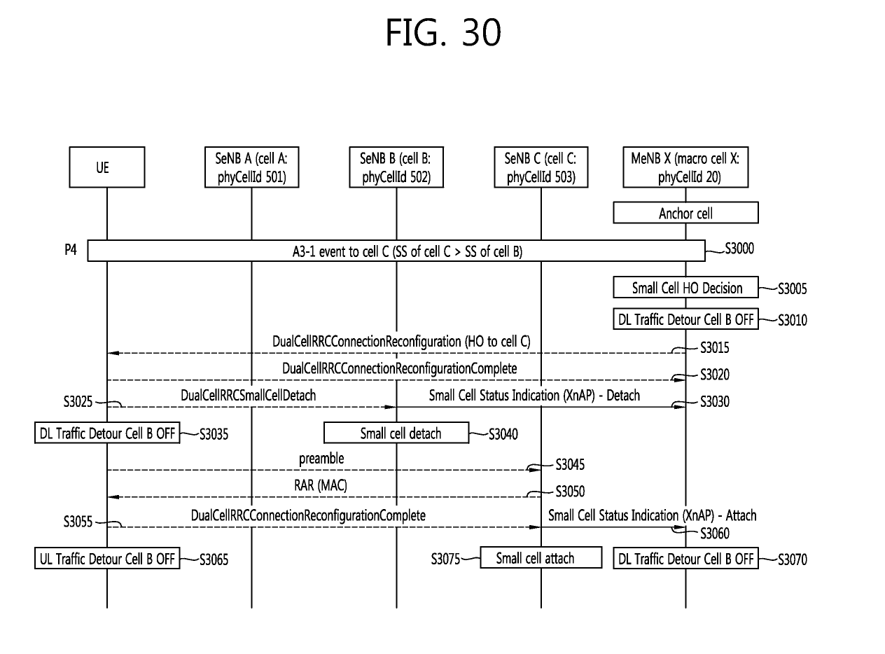

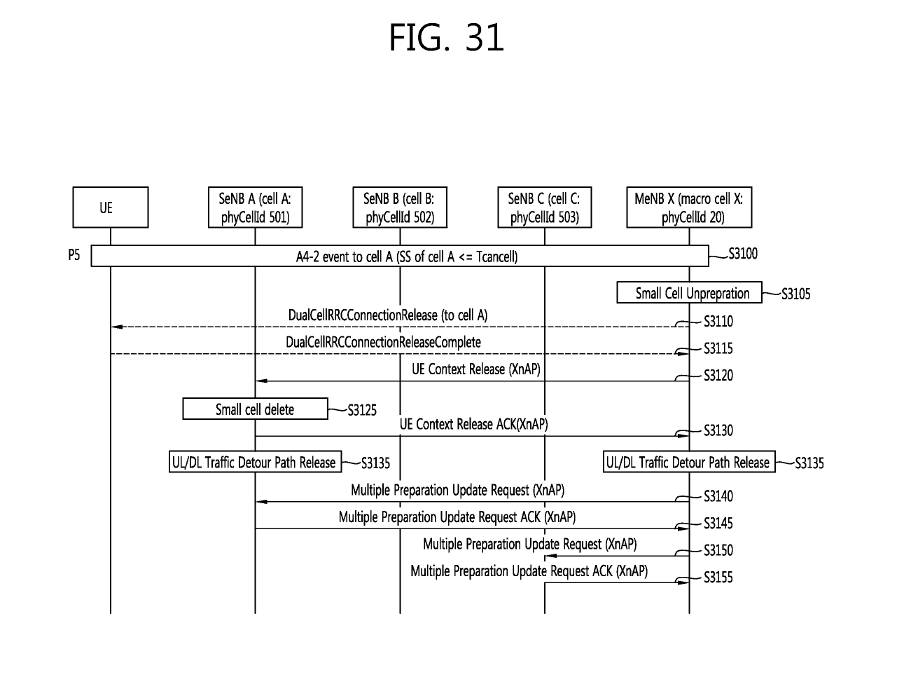

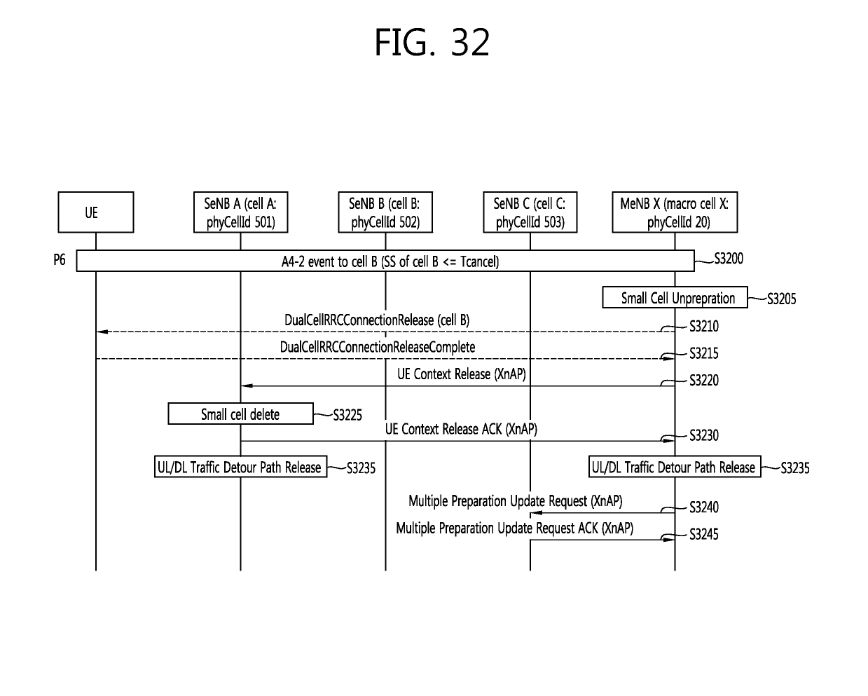

FIG. 27 to FIG. 32 below illustrates an example of the CFM operation procedure according to the position of a UE in FIG. 25. Particularly, FIG. 27 illustrates the CFM operation procedure according to each event in position P0 and Pa of a UE, FIG. 28 illustrates the CFM operation procedure according to each event in position P1 and P2 of a UE, FIG. 29 illustrates the CFM operation procedure according to each event in position P3 of a UE, FIG. 30 illustrates the CFM operation procedure according to each event in position P4 of a UE, FIG. 31 illustrates the CFM operation procedure according to each event in position P5 of a UE, and FIG. 32 illustrates the CFM operation procedure according to each event in position P6 of a UE. In FIG. 27 to FIG. 32, it is assumed the case that the physical cell ID of cell A of small eNB A is 501, the physical cell ID of cell B of small eNB B is 502, the physical cell ID of cell C of small eNB C is 503 and the physical cell ID of cell X of macro eNB X is 20. Herein, cell A, cell B and cell C may be called small cell A, small cell B and small cell C, respectively, and cell X may be called macro cell X.

First of all, referring to FIG. 27, in the state that cell X is the serving cell, according to the measurement result on position P0 of a UE, the event A4-1 for the case that the signal strength (SS) of cell A is greater than Tprep occurs (step, S2700).

Macro eNB X performs the preparation decision to cell A (step, S2705), and transmits the multiple preparation request message to small eNB A (step, S2710).

Small eNB A transmits the multiple preparation request ACK message to macro eNB X (step, S2715), and performs the preparation for cell A (step, S2720). The multiple preparation request message and the multiple preparation request ACK message may be transmitted through the Xn interface (or XnAP).

The detour two-way path is set up for the Xn-U between macro eNB X and small eNB A (that is, Xn traffic path) (step, S2725).

Later, in case that the UE moves to position Pa, according to the measurement result of the UE, the event A4-1 for the case that the signal strength of cell A is greater than Tborder occurs (step, S2730).

Macro eNB X performs the small cell addition decision for cell A (step, S2735), and transmits the Dual Cell RRC Connection Reconfiguration message for cell A to the UE (step, S2740).

The UE transmits the Dual Cell RRC Connection Reconfiguration Complete message to macro eNB X (step, S2745). In this case, the UE may transmit the Dual Cell RRC Connection Reconfiguration Complete message to small eNB A as well as to macro eNB X (not shown).

The UE transmits random access preamble for the random access procedure to small eNB A through the RACH (step, S2750). Small eNB A transmits the random access response (RAR) message to the UE (step, S2755). Later, the UE transmits the RRC connection reconfiguration complete message to small eNB A (step, S2760). Small eNB A transmits the multiple preparation request ACK message to macro eNB X (step, S2765). The multiple preparation request ACK message may be transmitted through the Xn interface (or XnAP). In this case, the UE may set up the uplink traffic detour ON (step, S2770), and macro eNB X may set up the downlink traffic detour ON (step, S2775). For example, in this case, the downlink packet may be transmitted to the UE through cell A, and the uplink packet may be transmitted macro eNB X through cell A.

Small eNB A performs the cell A addition procedure for the corresponding UE (step, S2780).

Through the procedures described above, macro eNB X may transmit or receive the whole or a part of the uplink/downlink packet for the UE through cell X, and small eNB A may transmit or receive the whole or a part of the uplink/downlink packet for the UE through cell A.

Later, referring to FIG. 28, in case that a UE moves to position P1, according to the measurement result of the UE, the event A4-1 for the case that the signal strength of cell B is greater than Tprep occurs (step, S2800).

Macro eNB X performs the preparation decision for cell B (step, S2805), and transmits the multiple preparation request message to small eNB B (step, S2810).

Small eNB B transmits the multiple preparation request ACK message to macro eNB X (step, S2815), and performs the preparation for cell B (step, S2820). The multiple preparation request message and the multiple preparation request ACK message may be transmitted through the Xn interface (or XnAP).

Macro eNB X and small eNB B set up the detour two-way path for the Xn-U (step, S2825).

Macro eNB X transmits the multiple preparation update request message to small eNB A in order to update the UE context information for cell C in cell A (step, S2830), and small eNB A transmits the multiple preparation update request ACK message to macro eNB X (step, S2835). The multiple preparation update request message and the multiple preparation update request ACK message may be transmitted through the Xn interface (or XnAP).

Later, in case that the UE moves to position P2, according to the measurement result of the UE, the event A4-1 for the case that the signal strength of cell B is greater than the signal strength of cell A occurs (step, S2840).

Macro eNB X performs the Small Cell HO Decision from cell A to cell B (step, S2845). Macro eNB X sets up the DL traffic detour to cell A as OFF (step, S2850). That is, it stops the DL traffic (or packet) transmission through cell A for the corresponding UE.

Macro eNB X transmits the Dual Cell RRC Connection Reconfiguration message toward cell B to the UE (step, S2855). The UE transmits the Dual Cell RRC Connection Reconfiguration Complete message to macro eNB X (step, S2860).

The UE transmits the Dual Cell RRC Small Cell Detach message for cell A to small eNB A (step, S2865). In this case, the UE deletes the information for small cell A yet. Small eNB A transmits the Small Cell Status Indication message that represents the detachment of cell A to macro eNB X (step, S2870).

The UE sets up the UL traffic detour for cell A as OFF (step, S2875), and small eNB A performs the cell A detach for the corresponding UE (step, S2880).

Later, the UE transmits the random access preamble for the random access procedure toward cell B to small eNB B through the RACH (step, S2885). Small eNB B transmits the random access response (RAR) message to the UE (step, S2886). Later, the UE transmits the RRC connection reconfiguration complete message to small eNB B (step, S2887). Small eNB B transmits the Small Cell Status Indication message that represents the attachment of cell B to macro eNB X (step, S2888). In this case, the UE may set up the uplink traffic detour ON (step, S2889), and macro eNB X may set up the downlink traffic detour ON (step, S2890). Small eNB B performs the cell B attach procedure for the corresponding UE (step, S2895). That is, in this case, the UE may transmit the UL traffic through cell B, and macro eNB X may transmit the DL traffic toward cell B.

Later, referring to FIG. 29, in case that the UE moves to position P3, according to the measurement result of the UE, the event A4-1 for the case that the signal strength of cell C is greater than Tprep occurs (step, S2900).

Macro eNB X performs the preparation decision for cell C (step, S2905), and transmits the multiple preparation request message to small eNB C (step, S2910).

Small eNB C transmits the multiple preparation request ACK message to macro eNB X (step, S2915), and performs the preparation for cell C (step, S2920). The multiple preparation request message and the multiple preparation request ACK message may be transmitted through the Xn interface (or XnAP).

Macro eNB X and small eNB C set up the detour two-way path for the Xn-U (step, S2925).

Macro eNB X transmits the multiple preparation update request message to small eNB A and small eNB B in order to update the UE context information for cell C in cell A and cell B (steps, S2930 and S2940), and small eNB A and small eNB B transmit the multiple preparation update request ACK message to macro eNB X (steps, S2935 and S2945). The multiple preparation update request message and the multiple preparation update request ACK message may be transmitted through the Xn interface (or XnAP).

Later, referring to FIG. 30, in case that the UE moves to position P4, according to the measurement result of the UE, the event A4-1 for the case that the signal strength of cell C is greater than the signal strength of cell B occurs (step, S3000).

Macro eNB X performs the Small Cell HO Decision from cell B to cell C (step, S2845). Macro eNB X configures the DL traffic detour to cell B as OFF (step, S3010). That is, it stops the DL traffic (or packet) transmission through cell B for the corresponding UE.

Macro eNB X transmits the Dual Cell RRC Connection Reconfiguration message toward cell C to the UE (step, S3015). The UE transmits the Dual Cell RRC Connection Reconfiguration Complete message to macro eNB X (step, S3020).

The UE transmits the Dual Cell RRC Small Cell Detach message for cell B to small eNB B (step, S3025). In this case, the UE deletes the information for small cell B yet. Small eNB B transmits the Small Cell Status Indication message that represents the detachment of cell B to macro eNB X (step, S3030).

The UE sets up the UL traffic detour for cell B as OFF (step, S3035), and small eNB B performs the cell B detach for the corresponding UE (step, S3040).

Later, the UE transmits the random access preamble for the random access procedure toward cell B to small eNB B through the RACH (step, S3045). Small eNB C transmits the random access response (RAR) message to the UE (step, S3050). Later, the UE transmits the RRC connection reconfiguration complete message to small eNB C (step, S3055). Small eNB C transmits the Small Cell Status Indication message that represents the attachment of cell C to macro eNB X (step, S3060). In this case, the UE may set up the uplink traffic detour ON (step, S3065), and macro eNB X may set up the downlink traffic detour ON (step, S3070). Small eNB B performs the cell C attach procedure for the corresponding UE (step, S3075). In this case, the UE may transmit the UL traffic through cell C, and macro eNB X may transmit the DL traffic toward cell C.

Later, in case that the UE moves to position P5, according to the measurement result of the UE, the event A4-2 for the case that the signal strength of cell A is as the same or smaller than Tcancel occurs (step, S3100).

Macro eNB X performs the un-preparation decision for cell A (step, S3105), and transmits the Dual Cell RRC Connection Release message for cell A to the UE (step, S3110). The UE transmits the Dual Cell RRC Connection Release Complete message to macro eNB X (step, S3115).

Macro eNB X transmits the UE context release message for cell A to small eNB A (step, 3120). Small eNB A performs the small cell un-preparation for cell A based on the UE context release message (step, S3125), and transmits the UE context release ACK message to macro eNB X (step, S3130). The UE context release message and the UE context release ACK message may be transmitted through the Xn interface (or XnAP).

Macro eNB X and small eNB A release the detour two-way path for the Xn-U (step, S3135).

Macro eNB X transmits the multiple preparation update request message to small eNB B and small eNB C in order to update the related information according to the preparation release of cell A to cell B and cell C (steps, S3140 and S3150), and small eNB B and small eNB C transmit the multiple preparation update request ACK message to macro eNB X (steps, S3145 and S3155).

Later, referring to FIG. 32, in case that the UE moves to position P6, according to the measurement result of the UE, the event A4-2 for the case that the signal strength of cell B is as the same or smaller than Tcancel occurs (step, S3200).

Macro eNB X performs the un-preparation decision for cell B (step, S3205), and transmits the Dual Cell RRC Connection Release message for cell B to the UE (step, S3210). The UE transmits the Dual Cell RRC Connection Release Complete message to macro eNB X (step, S3215).

Macro eNB X transmits the UE context release message for cell B to small eNB A (step, 3220). Small eNB B performs the small cell un-preparation for cell B based on the UE context release message (step, S3225), and transmits the UE context release ACK message to macro eNB X (step, S3230). The UE context release message and the UE context release ACK message may be transmitted through the Xn interface (or XnAP).

Macro eNB X and small eNB B release the detour two-way path for the Xn-U (step, S3235).

Macro eNB X transmits the multiple preparation update request message to small eNB B and small eNB C in order to update the related information according to the preparation release of cell B to cell C (step, S3240), and small eNB C transmits the multiple preparation update request ACK message to macro eNB X (step, S3245). The multiple preparation update request message and the multiple preparation update request ACK message may be transmitted through the Xn interface (or XnAP).

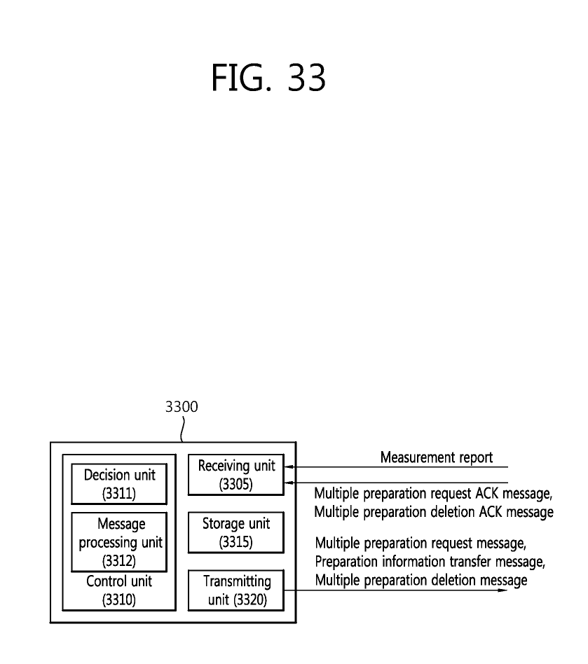

FIG. 33 is a block diagram schematically illustrating the eNB that performs the UE mobility management based on the MPM of the present invention.

Referring to FIG. 33, the eNB 3300 includes a receiving unit 3305, a control unit 3310, a storage unit 3315 and a transmitting unit 3320. The control unit 3310 performs the process and control to perform the operation according to Method 1 of the present invention described above. The control unit 3310 includes a decision unit 3311 and a message processing unit 3312.

The receiving unit 3305 receives the measurement report from a UE. The measurement report may be received from the UE through cell A operated by the eNB 3300. The cell A may be the serving cell for the UE. The eNB 3300 may be called eNB A. However, herein the expression of the eNB A is not to limit the eNB 3300 according to the present invention, but to distinguish the other eNBs (for example, eNB B and eNB C) which will be described below. The measurement report may include the measurement result for cell A. Also, the measurement report may include the measurement result of cell B and cell C, the neighboring cells. Herein, cell A, cell B and cell C may be small cells. The measurement result includes the strength of signals.

The decision unit 3311 performs the preparation decision for the neighboring cells based on the measurement report (or the measurement result). Herein, the preparation decision represents the decision that stores (or keeps) the UE context information for the corresponding UE for a specific cell among the neighboring cells, and the cell in which the UE context information for the corresponding UE exists may be called the prepared cell or the preparation cell. In this case, the preparation cells according to the MPM may store (or keep) the UE context information for all of the preparation cells for the corresponding UE.

For example, if the signal strength of a specific cell among the neighboring cells exceeds the threshold value Tprep, the decision unit 3311 may perform the preparation decision for the specific cell. Herein, the specific cell may be cell B and/or cell C described above.

Meanwhile, the measurement result for the neighboring cells which are included in the measurement result which is transmitted by a UE may be changed according to the move of the UE or the propagate environment. For example, if the UE is positioned on P1 of FIG. 6, the decision unit 3311 may perform the preparation decision for cell B based on the first measurement result, if the UE is positioned on P3 of FIG. 6, the decision unit 3311 may perform the preparation decision for cell C based on the second measurement result.

In addition, the preparation unit 3311 may also perform the un-preparation decision. For example, if the signal strength of a cell among the preparation cells is the same or smaller than a threshold value Tcancel for preparation release, the preparation unit 3311 may perform the un-preparation decision for the corresponding cell.

Also, if the UE context information for cell A is changed, the decision unit 3311 may decide the update of the changed UE context information for cell A for remainder preparation cells as well as cell A according to the MPM. For example, according to the success of the RLF recovery to cell A by the UE, the C-RNTI value of the UE for cell A may be changed. In this case, the decision unit 3311 determines that the UE context information for cell A is changed, and may decide the update of the changed UE context information for the remainder cell except cell A among the preparation cells.

The message processing unit 3312 generates the message for processing the related operation based on the decision of the decision unit 3311, and interprets and processes the message received by the receiving unit 3305.

As an example, in case that the decision unit 3311 performs the preparation decision for a specific cell (for example, cell C), the message processing unit 3312 may generate the (first) multiple preparation request message that indicates the multiple preparation of the specific cell. In this case, the multiple preparation request message may include the UE context information for the other preparation cells. In addition, in this case, for the remainder preparation cells (for example, cell B) except the serving cell (cell A) and the specific cell, the message processing unit 3312 may generate the preparation information transfer message that includes the UE context information for the specific cell in order to add the UE context information for the specific cell. In this case, the transmitting unit 3320 may transmit the multiple preparation request message to the eNB (for example, eNB C) that operates the specific cell (for example, cell C). Also, the transmitting unit 3320 may transmit the preparation information transfer message to the eNBs (for example, eNB B) that operates the remainder preparation cells (for example, cell B).

As another example, in case that the decision unit 3311 performs the un-preparation decision for the specific cell (for example, cell B) among the preparation cells, the message processing unit 3312 generates the multiple preparation deletion message that indicates the un-preparation for the specific cell. In this case, the transmitting unit 3320 transmits the preparation deletion message to the eNBs (for example, eNB B and eNB C) that operate the specific cell in which the un-preparation is decided or the remainder preparation cells (for example, cell C).

As still another example, in case that the decision unit 3311 decides the update for the changed UE context information due to the change of the UE context information for a specific cell (for example, cell A) among the preparation cells, the message processing unit 3312 may generate the (second) multiple preparation request message that indicates the update of the changed UE context information for the specific cell. In this case, the transmitting unit 3320 transmits the multiple preparation request message to the eNBs (for example, eNB B and eNB C) that operate the remainder preparation cells (for example, cell B and cell C) except the specific cell.

The receiving unit 3305 receives the (first) multiple preparation request ACK message that corresponds to the multiple preparation request message and the (second) multiple preparation request ACK message that corresponds to the multiple preparation request message that indicates the update of the changed UE context information for the specific cell.

The storage unit 3315 may store (or keep) the UE context information for the preparation cells according to the MPM and update it.

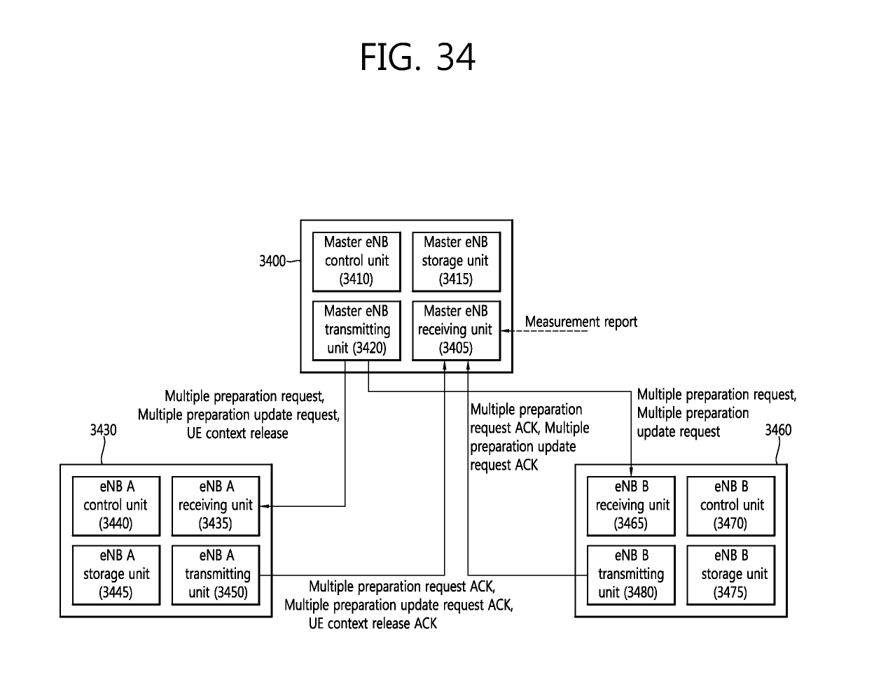

FIG. 34 is a block diagram schematically illustrating the eNBs that perform the UE mobility management based on the CFM of the present invention.

Referring to FIG. 34, the master eNB 3400 includes a master eNB receiving unit 3405, a master eNB control unit 3410, a master eNB storage unit 3415 and a master eNB transmitting unit 3420. The master eNB control unit 3410 performs the process and control for performing the operation according to Method 2 of the present invention described above.

The master eNB receiving unit 3405 receives the measurement report from the UE. The measurement report may be received from the UE through cell X which is operated by the master eNB 3400. The cell X may be the serving cell for the UE. The master eNB 3400 may be called master eNB X. The measurement report may include the measurement result of cell A, cell B and cell C which are the neighboring small cells. The measurement result includes the signal strength.

The master eNB control unit 3410 performs the preparation decision for the neighboring cells based on the measurement report (or the measurement result). Herein, the preparation decision represents the decision of storing (or keeping) the UE context information for the corresponding UE for a specific cell among the neighboring cells, and the cell in which the UE context information for the corresponding UE exists may be called the prepared cell or the preparation cell. In this case, the master eNB storage unit 3415 may stores (or keeps) the UE context information for all preparation cells for the corresponding UE according to the CFM. For example, in case that the signal strength of a specific cell among the neighboring cells exceeds the threshold value Tprep for preparation, the master eNB control unit 3410 may perform the preparation decision for the specific cell. Herein, the specific cell may be cell B and/or cell C described above. Meanwhile, according to the move of the UE or the propagation environment, the measurement result for the neighboring cells which are included in the measurement report which is transmitted from the UE may be changed. For example, in case that the UE is located at P1 of FIG. 14, the master eNB control unit 3410 may perform the preparation decision for cell B based on the first measurement result, and in case that the UE is located at P3 of GIG. 14, the master eNB control unit 3410 may perform the preparation decision for cell C based on the second measurement result.

In case that the master eNB control unit 3410 performs the preparation decision for a specific cell (for example, cell A and/or cell B), the master eNB control unit 3410 may generate the multiple preparation request message for indicating the multiple preparation of the specific cell. In this case, the multiple preparation request message may include the UE context information for the other preparation cells. Also, in this case, the master eNB control unit 3410, in order to add the UE context information for the specific cell with respect to the remainder preparation cells (for example, in case that cell A is the preparation cell and the specific cell is cell B) except the specific cell, may generate the multiple preparation update request message that includes the UE context information for the specific cell. In this case, the master eNB transmitting unit 3420 may transmit the multiple preparation request message to the eNB (for example, eNB B) that operates the specific cell (for example, cell B). Also, the master eNB transmitting unit 3420 may transmit the multiple preparation update request message to the eNB (for example, eNB A) that operates the remainder preparation cell (for example, cell A).

In addition, the master eNB control unit 3410 may also perform the un-preparation decision. For example, in case that the signal strength of a cell among the preparation cells is the same or smaller than Tcancel for preparation release, the master eNB control unit 3410 may perform the un-preparation decision for the corresponding cell.

In case that the master eNB control unit 3410 performs the un-preparation decision for a specific cell (for example, cell A) among the preparation cells, the master eNB control unit 3410 generates the UE context release message that indicates the preparation release for the specific cell. Also, the master eNB control unit 3410 may generate the multiple preparation update request message that instructs the deletion of the UE context information for the specific cell with respect to the remainder cells (for example, cell B) except the specific cell. In this case, the master eNB transmitting unit 3420 may transmit the UE context release message to the eNB (for example, eNB A) that operates the specific cell in which the un-preparation is decided. Also, the master eNB transmitting unit 3420 may transmit the multiple preparation update request message to the eNB (for example, eNB B) that operates the remainder preparation cell (for example, cell B).

In addition, the master eNB receiving unit 3405 receives the multiple preparation update request ACK message that corresponds to multiple preparation update request message instructing the multiple preparation of the specific cell, and receives the UE context release ACK message that corresponds to the UE context release message, may receive the (first) multiple preparation update request ACK message that corresponds to the multiple preparation update request message instructing the multiple preparation for the specific cell, and may receive the (second) multiple preparation update request ACK message that corresponds to the multiple preparation update request message instructing the deletion of the UE context information for the specific cell.

The eNB A 3430 includes an eNB A receiving unit 3435, an eNB A control unit 3440, an eNB A storage unit 3445 and an eNB A transmitting unit 3450. The eNB A control unit 3440 performs the process and control to perform the operation according to Method 2 of the present invention described above.

The eNB A receiving unit 3435 receives the multiple request message that indicates the multiple preparation of cell A from the master eNB 3400. Also, the eNB A receiving unit 3435 receives the multiple preparation update request message from the master eNB 3400. In addition, the master eNB A receiving unit 3435 receives the UE context release message from the master eNB 3400.

The eNB A control unit 3440 interprets and processes the message received by the eNB A receiving unit 3435. The eNB A control unit 3440 performs the cell preparation procedure based on the multiple preparation request message, and stores (or keeps) the UE context information for the preparation cells in the eNB A storage unit 3445. Also, the eNB A control unit 3440 may detect the addition of the other preparation cells based on the multiple preparation request message that indicates the multiple preparation of the specific cell, and further store the UE context information for the preparation cell which is added to the eNB A storage unit 3445. In addition, the eNB A control unit 3440 may perform the cell preparation deletion procedure based on the UE context release message, and delete the UE context information for the preparation cells from the eNB A storage unit 3445.

The eNB A transmitting unit 3450 may transmit the multiple preparation request ACK message, the (first) multiple preparation update request ACK message and the UE context release ACK message.

The eNB B 3460 includes an eNB B receiving unit 3465, an eNB B control unit 3470, an eNB B storage unit 3475 and an eNB B transmitting unit 3480. The eNB B control unit 3470 performs the process and control to perform the operation according to Method 2 of the present invention described above.

The eNB B receiving unit 3465 receives the multiple request message that indicates the multiple preparation of cell B from the master eNB 3400. Also, the eNB B receiving unit 3465 receives the (second) multiple preparation update request message that instructs the deletion of the UE context information for the specific cell from the master eNB 3400.

The eNB B control unit 3470 interprets and processes the message received by the eNB B receiving unit 3465. The eNB B control unit 3470 performs the cell preparation procedure based on the multiple preparation request message, and stores (or keeps) the UE context information for the preparation cells in the eNB AB storage unit 3475. Also, the eNB B control unit 3470 may detect the preparation release of the other preparation cells based on the multiple preparation update request message that indicates the deletion of the UE context information for the specific cell, and delete (or update) the UE context information for the preparation released cell from the eNB B storage unit 3475.

The eNB A transmitting unit 3450 may transmit the multiple preparation request ACK message and the (second) multiple preparation update request ACK message.

According to the present invention, in the new mobile communication system environment, the wireless resource management can be effectively performed.

So far, the present invention has been described by reference to the drawings and the embodiments as an example, and it should be understood by those skilled in the art, however, that the present invention can be modified or changed in various ways without departing from the technical principles and scope. Accordingly, the embodiments disclosed in the present invention are not intended to limit the scope of the inventive concept of the present invention, but to describe, and the scope of the inventive concept of the present invention is not limited to the embodiment. The scope of the present invention should be interpreted by the claims below, and it should be interpreted that all inventive concepts within the equivalent scope are included in the scope of the present invention.

What is claimed is:

1. A wireless communication system that supports mobility management in a small cell environment, comprising:
a user equipment configured to measure a signal strength of multiple small cells around and transmit the measurement result through a serving cell; and
a multiple small base stations configured to store user equipment context information in determined preparation cells among the multiple small cells based on the measurement result,
in case that the user equipment context information for cell A among the preparation cells is changed, wherein the multiple small base stations update the changed user equipment context information.

2. The wireless communication system of claim 1, wherein the small cells of which signal strength exceeds a threshold value Tprep for preparation based on the measurement result of the user equipment are determined to be the preparation cells.

3. The wireless communication system of claim 2, wherein the user equipment context information for the preparation cells includes physical IDs of each of the cells and C-RNTI of the user equipment for the corresponding cell.

4. The wireless communication system of claim 3, in case that signal strength of cell B among the multiple small cells exceeds the threshold value Tprep for the preparation, wherein the serving base station transmits multiple preparation request message that includes the user equipment context information for the preparation cells to small base station B that operates cell B, wherein the small base station B transmits multiple preparation request ACK message that includes the user equipment context information for corresponding cell B to the serving base station, and wherein the serving base station transmits preparation information transfer message that indicates addition of the user equipment context information for cell B to the remainder base stations except the serving base station.

5. The wireless communication system of claim 3, in case that signal strength of cell C among the preparation cells is the same or smaller than the threshold value Tcancel for release of the preparation, wherein the serving base station transmits multiple preparation deletion message that indicates un-preparation of cell C to small base station C and remainder base stations except the serving base station among the multiple base stations.

6. The wireless communication system of claim 3, wherein a change of the user equipment context information for the cell A is generated by success of radio link failure recovery to corresponding cell A by the user equipment.

7. The wireless communication system of claim 6, wherein the change of the user equipment context information for cell A is that C-RNTI of the user equipment for cell A is changed.

8. The wireless communication system of claim 3, wherein the serving base station transmits a multiple preparation request message that instructs update of the changed user equipment context information for cell A to remainder base stations except the serving base station among the multiple base stations, and
wherein the remainder base stations update the changed user equipment context information based on the multiple preparation request message.

9. A small base station that supports mobility management in a small cell environment, comprising:
a receiving unit configured to receive a first measurement report including a first measurement result for cell B from a user equipment through cell A;
a storage unit configured to store user equipment context information for cell A;
a control unit configured to perform a preparation decision for cell B in case that signal strength of cell B exceeds a threshold value Tprep for preparation based on the first measurement result for cell B, and generates a first multiple preparation request message including the user equipment context information for cell A; and
a transmitting unit configured to transmit the generated first multiple preparation request message to a small base station B that operates cell B,
wherein the receiving unit receives a first multiple preparation request ACK message including the user equipment context information for cell B from small base station B, and
wherein the control unit controls such that the user equipment context information for the cell B as well as the user equipment context information for cell A is to be stored in the storage unit.

10. The small base station of claim 9, wherein the user equipment context information for cell A includes a physical cell ID for cell A and C-RNTI of the user equipment for cell A, and wherein the user equipment context information for cell B includes a physical cell ID for cell B and C-RNTI of the user equipment for cell B.

11. The small base station of claim 10, in case that the user equipment context information for cell A is changed, wherein the control unit generates a second multiple preparation request message that instructs update of the changed user equipment context information for cell A,
wherein the transmitting unit transmits the generated second multiple preparation request message to small base station B, and
wherein the receiving unit receives a second multiple preparation request ACK message from small base station B.

12. The small base station of claim 11, according to success of RLF recovery to cell A by the user equipment, in case that the C-RNTI for the user equipment for cell A is changed, wherein the control unit determines that the user equipment context information for cell A is changed.

13. The small base station of claim 10, wherein the receiving unit receives a measurement report including a measurement result for cell C from the user equipment through cell A,
wherein the control unit performs a preparation decision for cell C in case that signal strength of cell C exceeds the threshold value Tprep for preparation based on the measurement result for cell C, and generates a second multiple preparation request message including the user equipment context information for cell A and cell B,
wherein the transmitting unit transmits the second multiple preparation request message to a small base station C that operates cell C,
wherein the receiving unit receives a second multiple preparation request ACK message including the user equipment context information for cell C, and
wherein the transmitting unit transmits a preparation information transfer message including the user equipment context information for cell C to small base station B.

14. The small base station of claim 10, wherein the receiving unit receives a second measurement report for cell B from the user equipment through cell A,
wherein the control unit performs un-preparation decision for cell B in case that the second measurement result for cell B is the same or smaller than a threshold value Tcancel for preparation release, and generates a multiple preparation deletion message that indicates un-preparation for cell B, and
wherein the transmitting unit transmits the second multiple preparation deletion message to small base station B.

15. A method of mobility management in small cell environment, comprising:
receiving a first measurement report including a first measurement result for cell B from a user equipment through cell A;
storing user equipment context information for cell A;
performing a preparation decision for cell B in case that signal strength of cell B exceeds a threshold value Tprep for preparation based on the first measurement result for cell B,
generating a first multiple preparation request message including the user equipment context information for cell A;
transmitting the generated first multiple preparation request message to a small base station B that operates cell B;
receiving a first multiple preparation request ACK message including the user equipment context information for cell B from small base station B, and
controlling such that the user equipment context information for the cell B as well as the user equipment context information for cell A is to be stored in the storage unit.

16. The method of mobility management of claim 15, wherein the user equipment context information for cell A includes a physical cell ID for cell A and C-RNTI of the user equipment for cell A, and wherein the user equipment context information for cell B includes a physical cell ID for cell B and C-RNTI of the user equipment for cell B.

17. The method of mobility management of claim 16 further comprising:
in case that the user equipment context information for cell A is changed, generating a second multiple preparation request message that instructs update of the changed user equipment context information for cell A,
transmitting the generated second multiple preparation request message to small base station B, and
receiving a second multiple preparation request ACK message from small base station B.

18. The method of mobility management of claim 17, wherein the change of the user equipment context information for cell A is generated with the C-RNTI for the user equipment for cell A being changed according to success of RLF recovery to cell A by the user equipment.

19. The method of mobility management of claim 16 further comprising:
receiving a measurement report including a measurement result for cell C from the user equipment through cell A,
performing a preparation decision for cell C in case that signal strength of cell C exceeds the threshold value Tprep for preparation based on the measurement result for cell C, and generates a second multiple preparation request message including the user equipment context information for cell A and cell B,
transmitting the second multiple preparation request message to a small base station C that operates cell C,
receiving a second multiple preparation request ACK message including the user equipment context information for cell C, and
transmitting a preparation information transfer message including the user equipment context information for cell C to small base station B.

20. The method of mobility management of claim 16 further comprising:
receiving a second measurement report for cell B from the user equipment through cell A,
performing un-preparation decision for cell B in case that the second measurement result for cell B is the same or smaller than a threshold value Tcancel for preparation release, and generating a multiple preparation deletion message that indicates un-preparation for cell B, and
transmitting the second multiple preparation deletion message to small base station B.
